(19) United States
(12) Patent Application Publication
(10) Pub. No.: US 2005/0075925 A1
(43) Pub. Date: Apr. 7, 2005

(54) Web-based address book

(76) Inventor: Yaakov Sash, Brooklyn, NY (US)

Correspondence Address: KAPLAN & GILMAN , L.L.P., 900 ROUTE 9 NORTH, WOODBRIDGE, NJ, 07095, US

(21) Appl. No.: 10/315,315

(22) Filed: Mar. 25, 2003

Related U.S. Application Data
(62) Division of application No. 09/565,399, filed on May 5, 2000, now abandoned.

(51) Int. Cl. G06F 17/60

(52) U.S. Cl. 705/14

(57) ABSTRACT

Disclosed is an Internet-based address book that enables individuals (“users”) or (“members”) to use people (“contacts”) from their address book for event planning, purchasing gifts, marketing, and anything else anyone dreams up. The system includes the following modules: an address book whose information can be utilized by any client for any purpose, a full-fledged event planner suitable for planning formal events such as weddings, a marketing module that allows people to refer products and information to people who would be interested, and a recipient transaction module that makes recipient-based transactions such as gifts and money transfer assessable and convenient. Features of the event planner include automatic generation and reprinting of invitations, placement cards, and thank-you cards with proper etiquette. Features of the marketing module includes the ability (a) to restrict the contacts that can be marketed to based on demographics, negative feedback, missing requisite information, or other reasons, (b) to reward users that market merchandise to their contacts with a discount on the merchandise itself, and (c) to bundle all the marketing sent by all users to one contact and deliver it as a single consolidated information package. Features of the recipient transactions module include the ability to (a) send one person a gift through postal mail or email, (b) send many people a gift, and (c) allow many people to purchase a single gift together.

### TECHNICAL FIELD

This invention relates to expert systems, and particularly, to information processing and event planning via the Internet.

### BACKGROUND OF THE INVENTION

Although there are more and more ways for people to communicate with each other, it has become more and more difficult for people to keep track of each other's contact information. People can be contacted through mailing addresses, email addresses, phone numbers, and instant messaging. A person's address book becomes out of date whenever someone in it moves or changes jobs. There are many software and Internet-based solutions that attempt to solve this problem. However, they do not make adequate use of the contact information contained within. Additionally, they do not have provisions for users to share their address book with each other. Consequently, people that use current address book solutions are unable to use it to its full advantage.

Another problem commonly faced by people is event planning. Event planning is a time-consuming arduous ordeal that include many tasks, such as: creating a guest list, locating and verifying addresses, tracking RSVP, printing invitations, creating a seating chart, printing place cards, tracking gifts, and writing thank-you cards. Although there are many websites that allow people to manage this process, they have many deficiencies, including:
(a) only one person can plan an event because they do not contain a security model and audit log; and
(b) can only be used for informal events because the invitations are only sent by email.

There are many software products that attempt to automate event planning. However, software products have the following deficiencies:
(c) the fact that multiple users can not collaborate and plan an event together is especially limiting for formal events such as weddings because it is usual for the bride and groom and their families to plan the event together;
(d) is effectively limited to one event per software installation and does not allow for reporting across multiple events;
(e) requires duplicate address information that is stored for guests;
(f) does not automatically apply rules of etiquette when addressing invitations, place cards, and thank you cards;
(g) cannot automatically search the Internet for the guest's email address, phone number, and mailing address and copy the information into the guest record if found;
(h) people have to call their guests to verify their mailing address and the spelling of the guests' (and all children's) names. Even if a user did it once, he still has to do it again for the next event, because the guest may have moved or family status may have changed;
(i) guests' addresses and phone numbers are not automatically updated from the marketing industry's databases;
(j) A family member cannot easily reuse a person's guest list; and
(k) there is no infrastructure for 3^{rd} party venders to be able to plug into to provide products & services that utilize the guest list.

Another problem faced by companies, is that with the increasing popularity of the Internet and the World Wide Web, it has become increasingly difficult for companies to market their product and services effectively. Although people may be interested in products and services that companies have to offer, they suffer from information overload and have no way of sifting through the information that is thrown at them. Consequently they turn themselves off and ignore all marketing overtures. Banner ads clickthrough rates are at an all time low because, as researchers explain, people have trained their eyes to instinctively ignore any graphic in the shape of a banner ad. The same problem exists for email because people are inundated with so much unsolicited email (“spam”) that they delete it without ever reading it. Also, email providers are taking technical measures to remove spam even before it gets to the user's inbox. Email may be cheap to send, but the cost of sending unsolicited email is that it damages the long-term relationship between the marketer and the consumer. In some cases, it may be even illegal or unethical to target certain people (e.g., children.) Consequently, the goal of all marketers should be to only send something to the consumer that there is a reasonable chance that the consumer is interested in reading it. There is no way for mass marketing campaigns to accomplish this because:
(a) it is not cost-effective to try to quantify what every consumer is interested in. In fact, it may be impossible;
(b) have no way of taking family status into account. For people that are married, it may be more appropriate to target one spouse over the other. In some cases, both spouses should be targeted;
(c) Permission marketing (“opt-in”) programs, in which people can choose to receive marketing email on selected topics that is of interest to them, does not solve the problem either because:
   a. many people treat opt-in programs as disguised spam and will never sign up,
   b. a person will not always take the time to adjust their selected topics when their interests change, especially if it is for a short duration,
   c. a person may not even realize that he is interested in a particular topic because of semantic differences,
   d. people are very complex and it is difficult to classify all possible combinations of interests that a person may have (e.g., a person may be only interested in old films that star a particular actor, but the opt-in program will just having a topic called “Movies.”),
   e. the programs must adhere to the request of the user. If a user says to turn off a particular topic, the program is not permitted to violate its own agreement, even though in theory the user may be interested in a particular piece of information,
   f. The way that some opt-in programs work is that they buy email addresses from third-party web-sites and enroll the person into the opt-in program with every topic enabled. When the person receives the first email, they are encouraged to visit the opt-in website to turn off topics that they are not interested in. If a person only deals with reputable websites and requests that they do not give out his email address, there is no way for the opt-in programs to target this person, and
   g. Because of these problems, many companies have been forced to market their product and services through television, magazine, and newspaper advertisements which can be prohibitively expensive.

The present invention addresses these and other problems.

### SUMMARY OF THE INVENTION

The present invention provides a software system and method to allow an Internet proprietor referred to herein as “addressHawk.com” to (a) provide an address book that maximizes the value of the contacts maintained within, (b) allow people to plan events more effectively, (c) allow companies to market their product and services more effectively, and (d) allow people to perform recipient-based transactions more easily.

In accordance with the address book aspect of the invention, once users enter their contacts, they can use them in the following manner:
(a) External applications;
(b) Event planning, which includes addressing invitations, creating a seating chart, printing place cards, and addressing thank-you cards; and
(c) Marketing.
(d) Recipient transactions.

In accordance with the event planning aspect of the invention, the event planning subsystem provides methods to extend invitations to guests, address invitations, track RSPV, create seating charts, print place cards, enter gifts, and write thank-you cards.
(a) Multiple users share their information and collaborate together, the address book and event planner can be shared between multiple users. This is controlled by a full security model and audit log. The security model allows the user to designate a subset of information to be shared with another user as well as a set of privileges that allows the share user to perform designated actions and tasks. The audit log is a record of all changes that is made to a user's information, including changes that the user himself. The audit record includes the date and time that the change was made, the name of the person who made the change, the change that was made, and what it was changed from. If a lot of changes are made, the audit log can fill up very quickly, and may be emptied and emailed to the user. The sharing feature also allows other people (e.g., a brother or sister) to reuse a user's guest list without maintaining a separate copy.
(b) Guests can be reused for as many events as necessary.
(c) The number of duplicate addresses are reduced by allowing many contacts from the same household to be entered together in a single household with one address. Rules of etiquette are used when addressing invitations, place cards, and thank you cards. The user simply selects the guests that are being addressed together, and the module automatically applies the rules of etiquette. The user has the option of adjusting the combined name if it is not to his liking.
(d) To search the Internet based on the first and last name of a guest and show the user a list a best matches. The preferred embodiment is to search multiple white pages on the Interest and allow the user to choose the address and phone number he feels is most accurate. When an address is selected, all abbreviations will be unabbreviated for proper etiquette.
(e) To be able to create and invite to multiple events at the same time. An example of this would be a wedding and bridal shower. It makes it more efficient to add guests into the address book as well as invite them to both events at the same time.
(f) Links to gift registries and other retailers are provided.

In accordance with the marketing aspect of the invention, the marketing subsystem provides methods to:
(a) allow any website to have a hyperlink, which transport their user into their address book where they can select the appropriate contacts to market the information to.
(b) restrict the type of contact that can be chosen based on demographics, negative feedback, missing requisite information, if the contact was already marketed to for this campaign, or if the contact was marketed to in too short of a span
(c) to reward user financially for marketing to their contacts. The reward is based on how close the chosen contacts meet the ideal demographic and other criteria.
(d) to reward users that market merchandise to their contacts with a discount on the merchandise itself.
(e) to bundle together all the marketing sent to one contact from many users and deliver it as a single consolidated information package.

In accordance with the recipient transactions aspect of the invention, the recipient transaction subsystem provides methods to:
(a) send a person a gift, money, or anything else through email or postal mail.
(b) send many people a gift or card (real or virtual) at once.
(c) allow many people to purchase a single gift. The item doesn't ship until everyone agrees to pay and each person is billed separately.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level architectural drawing illustrating the primary components of a system that operates in accordance with the present invention;

FIG. 2 is a high-level flow diagram illustrating the primary components of the present invention;

FIG. 3 is a high-level flow diagram illustrating the address book component;

FIG. 4 is a high-level flow diagram illustrating the event component;

FIG. 5 is a high-level flow diagram illustrating the marketing component;

FIG. 6 is a high-level data diagram illustrating the relationships between the profile, address, event, sharing, and audit databases;

FIG. 7 is a data diagram illustrating the structure of the profile database;

FIG. 8 is a data diagram illustrating the structure of the address book database;

FIG. 9 is a data diagram illustrating the structure of the event database;

FIG. 10 is a data diagram illustrating the structure of the marketing database;

FIG. 11is a data diagram illustrating the structure of the sharing databases;

FIG. 12 is a data diagram illustrating the structure of the audit databases;

FIGS. 13a-13e is a sequence of screens that demonstrates how new members are added to the address book component;

FIG. 14 is a data graph illustrating the structure of the address book depicted in FIGS. 13a-13e;

FIGS. 15a-15f is a sequence of screens that demonstrate the synchronization functionality of the address book component;

FIGS. 16a-16b are data graphs illustrating the structure of address books in which a member get married and changes household;

FIGS. 17a-17d is a sequence of screens that demonstrate the addressing invitations functionality of the event component;

FIGS. 18a-18e is a sequence of screens that demonstrate the writing place card functionality of the event component;

FIG. 19 is a screen that demonstrates the etiquette functionality of the event component;

FIGS. 20a-20e is a sequence of screens that demonstrate the writing and addressing thank-you cards functionality of the event component;

FIG. 21 is a data graph illustrating the structure of the event database depicted in FIGS. 17a-17d, 18a-18e, and 20a-20e;

FIGS. 22a-22d is a sequence of screens that demonstrate the automated correction and reprint functionality of the event component;

FIG. 24 is a data graph illustrating the structure of the sharing database;

FIGS. 25a-25c is a sequence of screens that demonstrate the utilization functionality of the address book component;

FIG. 26 is a detailed sequence diagram illustrating the required steps to accomplish the utilization functionality as depicted in FIGS. 25a-25c;

FIGS. 27a-27c is a sequence of screens that demonstrate the bulletin and feedback functionality of the marketing component;

FIGS. 28a-28b is a detailed sequence diagram illustrating the required steps to accomplish the bulletin and feedback functionality as depicted in FIGS. 27a-27c;

FIG. 29 is a data graph illustrating the structure of the marketing database as depicted in FIGS. 27a-27c; and

FIGS. 30a-30b is a sequence of screens that demonstrate the product bulletin functionality of the marketing component.

### DETAILED DESCRIPTION OF THE PREFERRED EMBODIMENTS

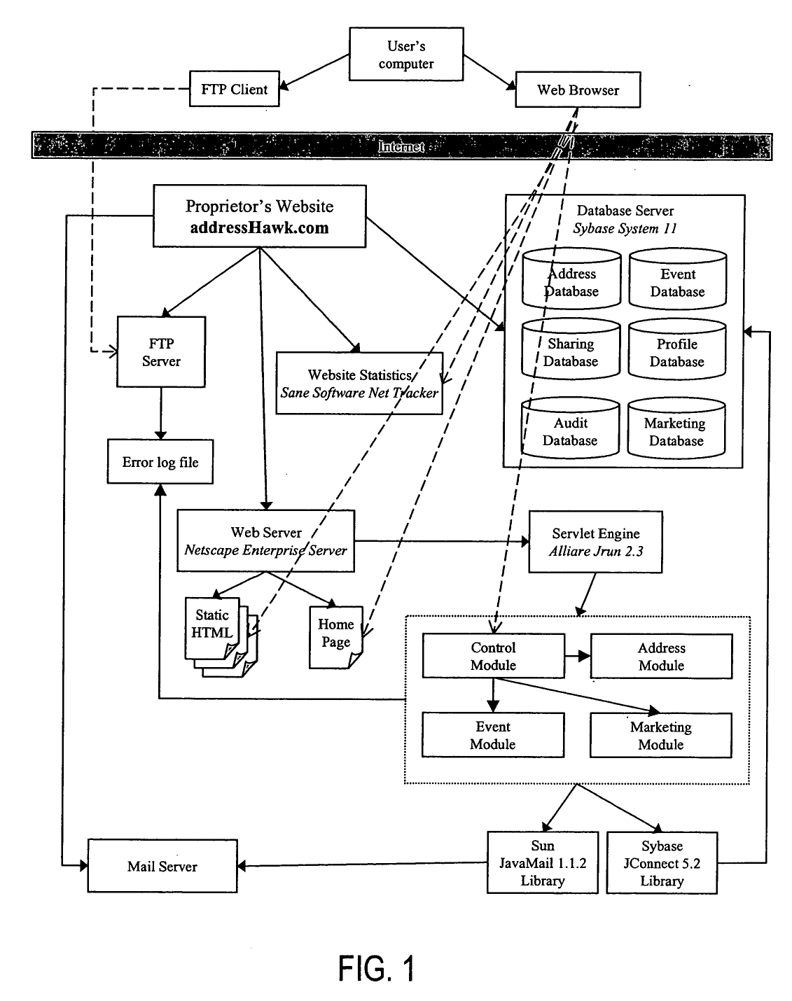

FIG. 1 illustrates the general architecture of the system that operates in accordance with the present invention. The system includes a user's computer and a proprietor's website linked together by the Internet. The user's computer may be any type of computing device that allows a user to interactively browse web sites via a web browser.

The proprietor's website is a site that hosts the application logic and the address, event, and marketing databases in which users personal information is stored. In the implementation described herein, the proprietor's website is the site of addressHawk.com.

The following components may be contained in the proprietor's website: Netscape web server, Jrun servlet engine, mail server, Sybase Database, Sane Software NetTracker, and FTP Server. These elements are known to those in the art, and are not critical to the present invention. A variety of techniques may be used to implement the features described herein on a website.

A user connects to the home page of the website by typing in the URL of the website into their web browser from any computer that is connected to the Internet.

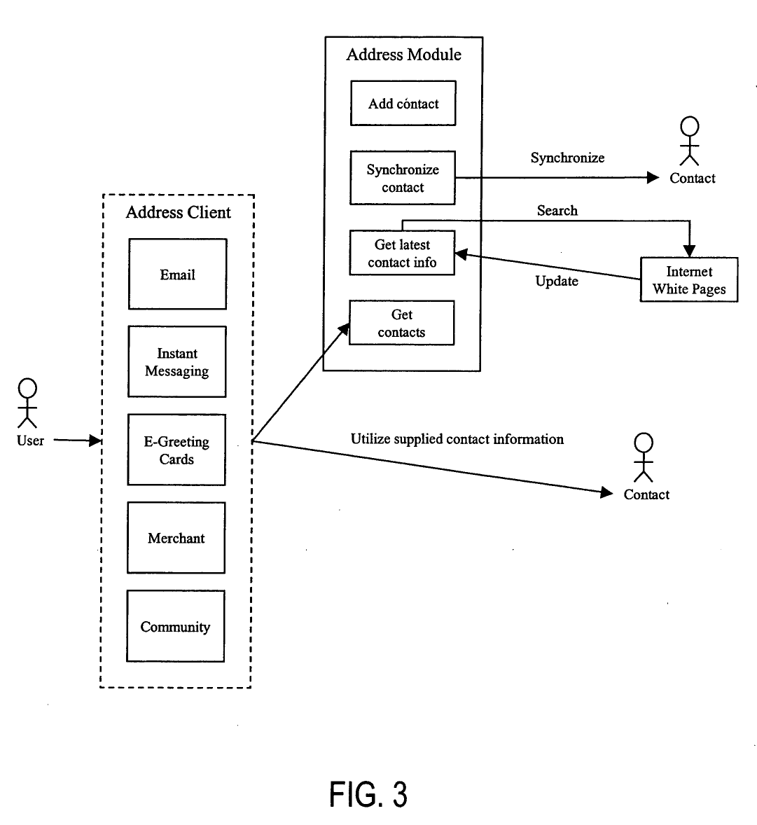

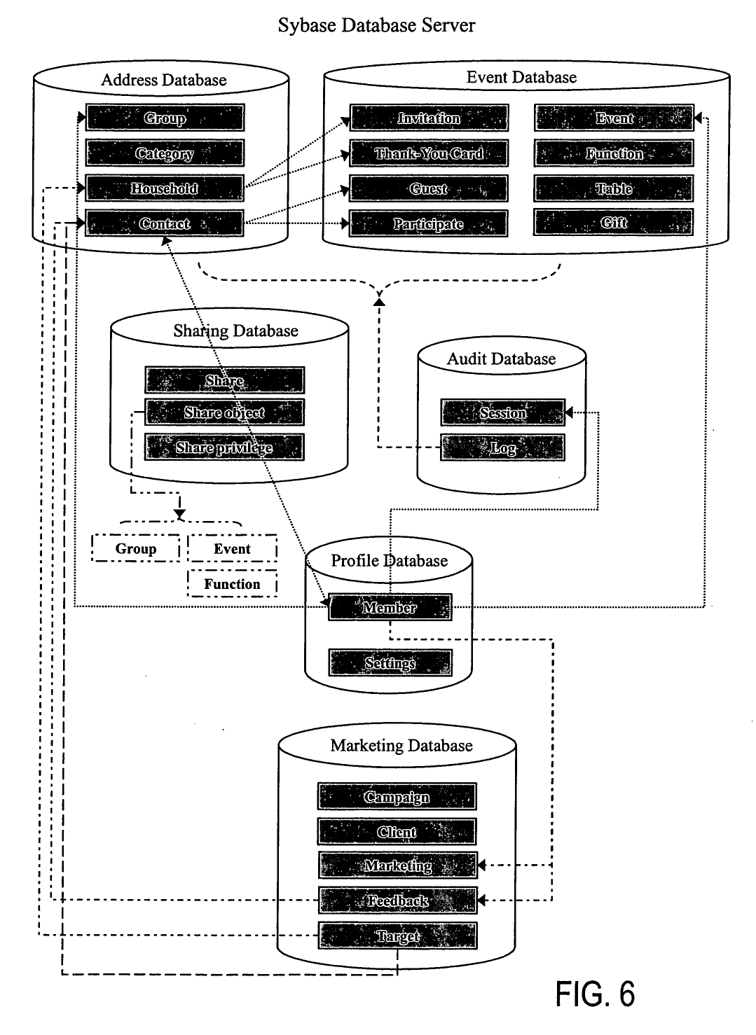

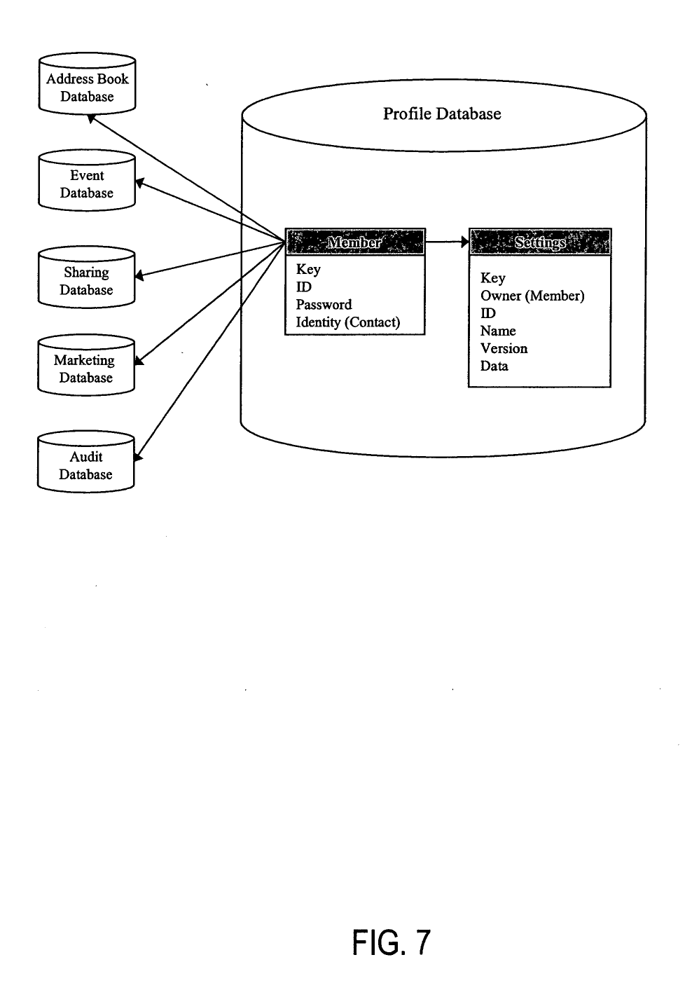

The data stored is broken into 6 logical databases. See FIG. 6 for a high-level diagram of all databases. The address database stores names and address type information and is described in FIG. 3.

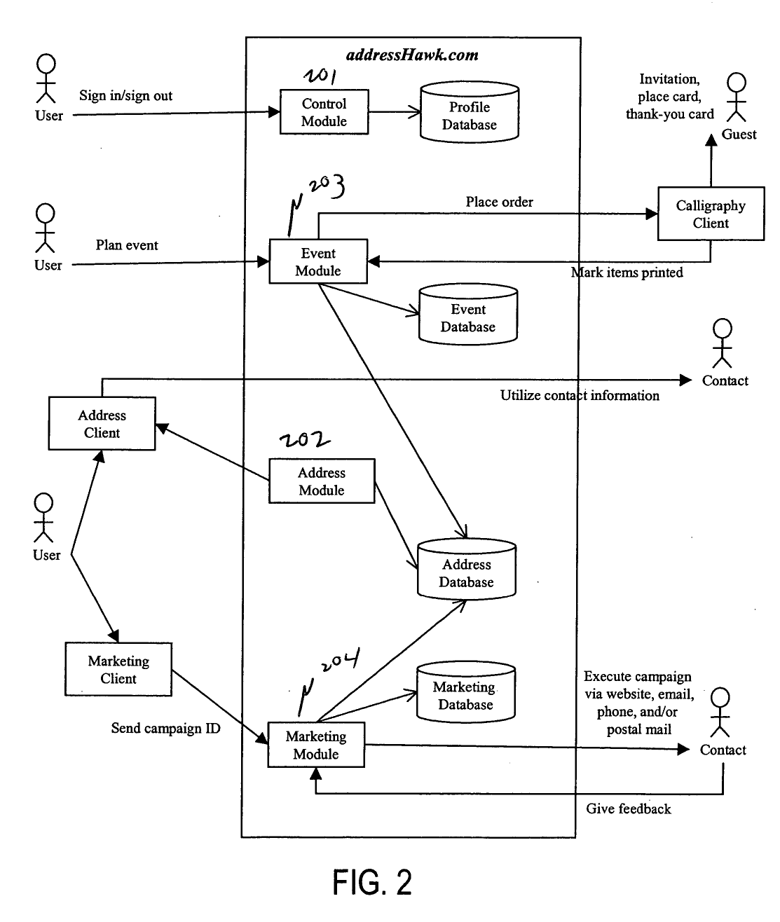

FIG. 2 illustrates the primary functions of the present invention:
(a) The control module 201 is responsible for letting users sign in and sign out and for delegating user's requests to the proper module;
(b) The address module 202 is responsible for allowing users to add and change contact information, synchronize contact information with other members, synchronize contact information off the Internet, and for allowing users to utilize their contact information with other websites and software packages (“address clients”);
(c) The event module 203 is responsible for allowing users to utilize the household information stored in the address database to plan events, and to simplify the process of writing and addressing invitations, place cards, and thank-you cards; and
(d) The marketing module 204 is responsible for allowing users to utilize their contact information for marketing-related purposes. Additional functionality has to be provided on top of the address module to manage the effects and increased responsibility of financially compensating users for supplying contacts for marketing purposes. The marketing module accomplishes these goals by having users only target contacts that are the most interested in the product (less is better), and by allowing users to post product bulletins in their account that other contacts can search at their own convenience.

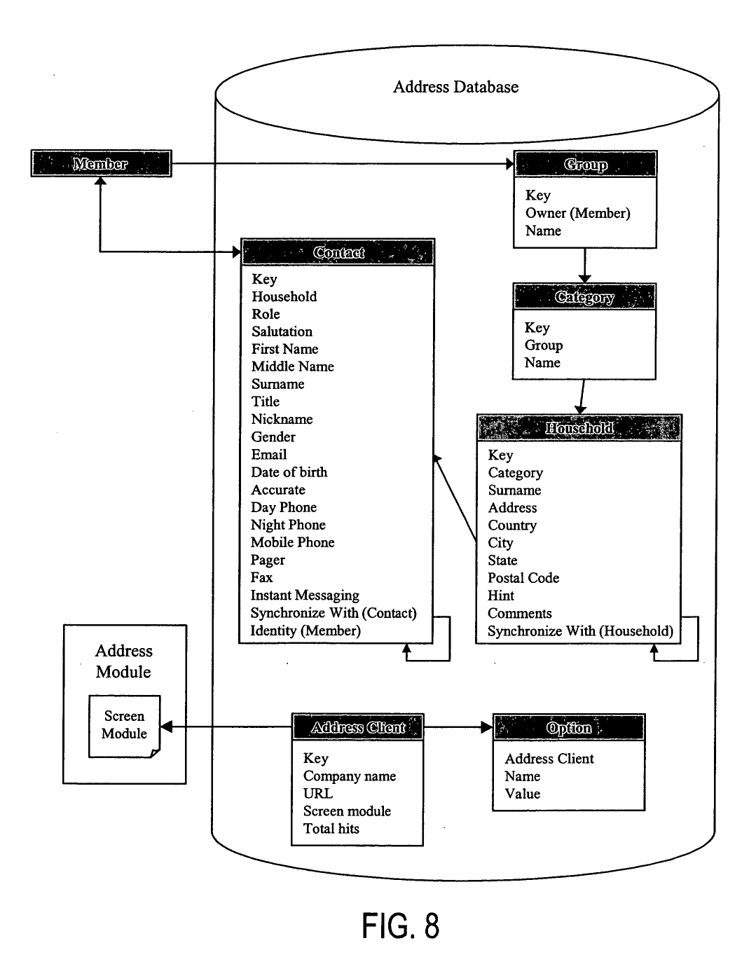

FIG. 3 illustrates the primary functions of the address module. FIG. 8. illustrates the database used by the address module. For some functions, there may be a sequence of screens that demonstrate the functionality being used.

The over-all goal of the address component is to improve the accuracy of the information stored in an online address book.

One of the ways to improve the accuracy of data is by having a single person who is the closest to the given contact be responsible to add and maintain their information. If two sisters are getting married one after the other, why should both of them have to track down and maintain the same great-aunt's address? Users only add and maintain their own contacts, but share other user's address books for the contacts that they don't have (sharing will be discussed later in greater detail.) Contacts are organized into groups and categories. The “My” group and “Household” category are permanent and the names cannot be modified by the users. All additional groups and categories are semantically defined by the user and can be any combination of letters and numbers. For example, within the “My” group, the user can organize the contacts into categories such as “Family”, “Work”, “College”, “Friends”. If a user's wife has an address book, she will have her own “My” group and whatever categories she may need. And the same applies to the user's parents. Each parent of the user and the user's wife will have their own top-level “My” group. In the best case scenario, a user would only need a single “My” group, and every person will only have to be responsible for contacts that they know directly. However, for the example just given to work, we would need all 6 people to be users, which is not something that we can be dependant on. For that reason, if a user's wife is computer-phobic, and does not want to maintain her own contacts, her husband can do it for her. In that case, the husband would create a new group called “My Wife” and use it to add and maintain all of his wife's contacts for her. When the wife relents and becomes a member, the “My Wife” group will be renamed “My” and moved into the wife's account.

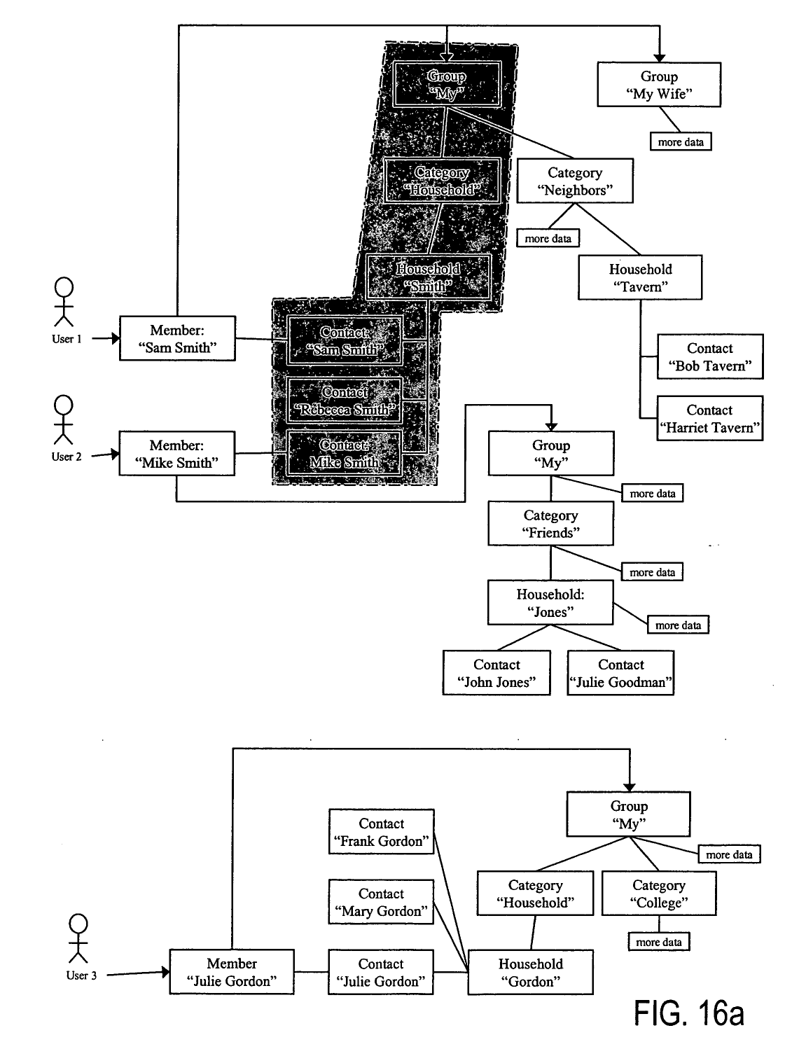

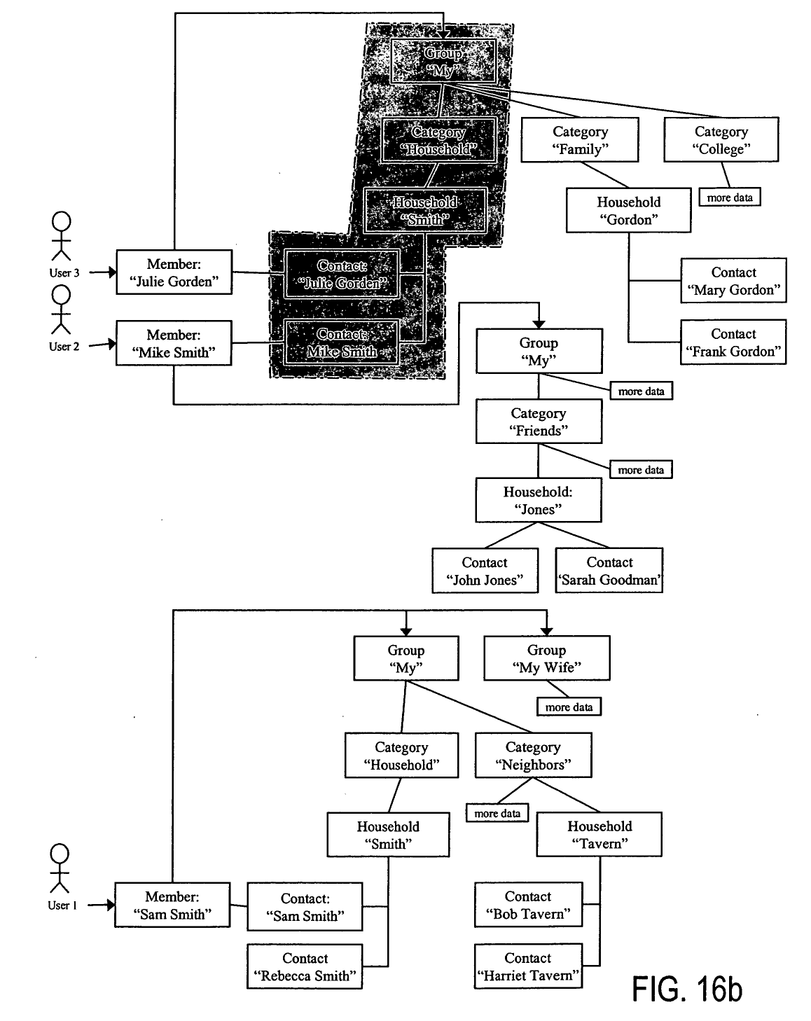

In the example of when a contact gets married, the contact data is simply associated to a new household. None of the information associated with that contact is lost. This is illustrated in FIGS. 16a and 16b. In FIG. 16a, Mike Smith is part of Sam Smith's household, and Julie Gordon is a part of her own household. Once Mike and Julie get married (FIG. 16b), Mike is moved into Julie's household. Notice that everyone still has the same contacts in their respective groups, and that no information has been lost.

Another reason why information may become inaccurate is because the same information has to be maintained for many contacts (“duplicate data”). For this reason, the database has been structured around the concept of a household. A household contains at least one or more contacts. The information that is stored in an household is the information that is common to all contacts of the household, such as an mailing address. (Although multiple addresses are not contained in the current design, it will be recognized by those skilled in the art that it is a minor enhancement.) Information that applies to a particular contact, such as name, age, and phone number, can be different for each contact. In addition, a primary contact has to be specified for a household. If information is not supplied for a contact (e.g., phone), the primary contact's information is used instead. When an address for a given household is changed, all the contacts in that household are given the new address.

Another way that the address module was designed to minimize duplicate information, is by automatically adding a person's household information to the “My: Household” category when they become a member. Whenever a member changes their personal household information, the changes will be available to who ever they are sharing the “My: Household” category with. This is a advantageous feature because people have to account for themselves as guests at their own events which many people forget, plus users may be sharing their address book with siblings (for example) who must send the user an invitation.

Another reason why information becomes inaccurate is because life is full of change. People get married, divorced, change jobs, buy houses, go to college. For this reason, the address module was designed to allow members synchronize their household information with each other. And because not every person will always be on the ball (or even truthful), the synchronization feature allows a user to maintain their own copy of the information that can be different from the member they are synchronizing with. This is a very important feature to have because some people may forget to update their information (which is what is being synchronized out) and some people may want to hide their real information.

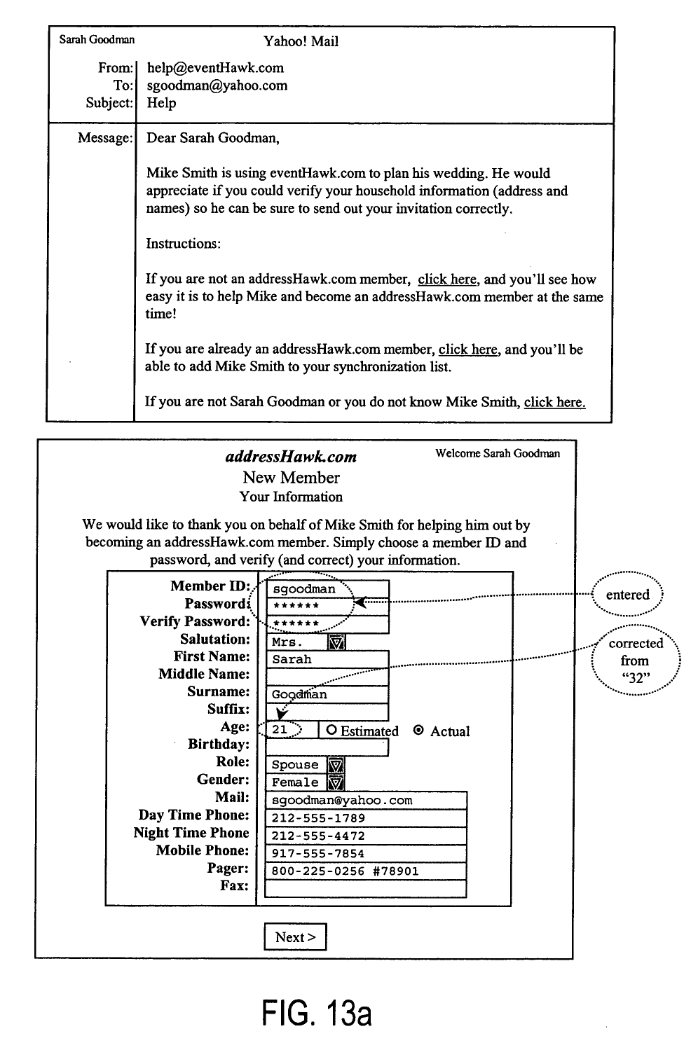

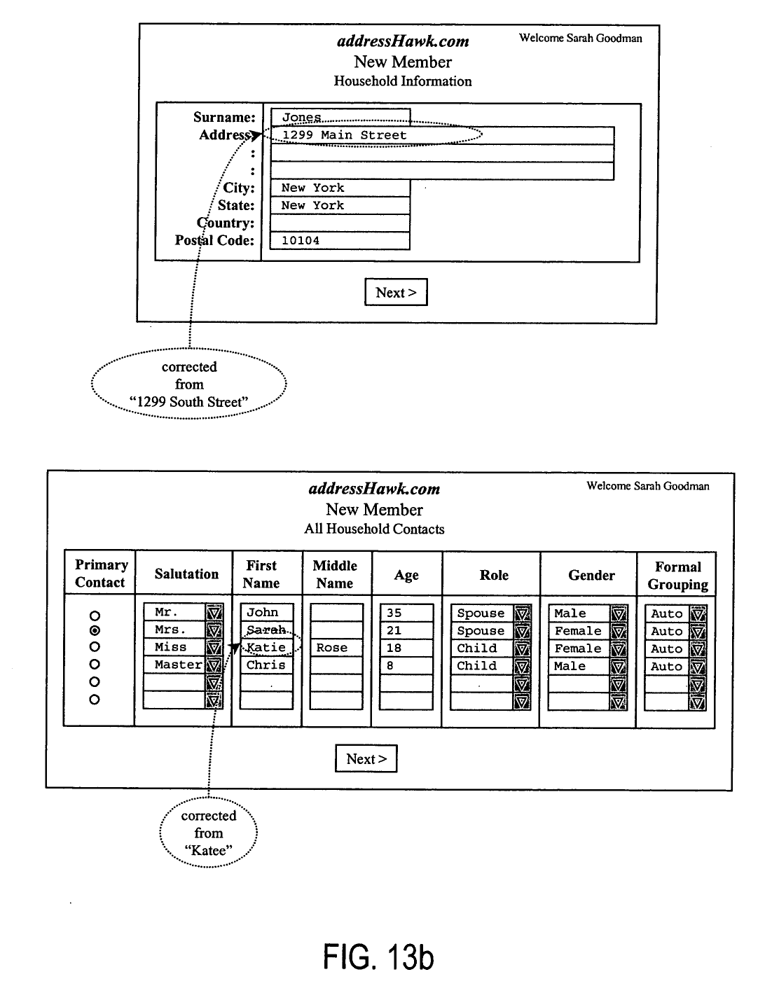

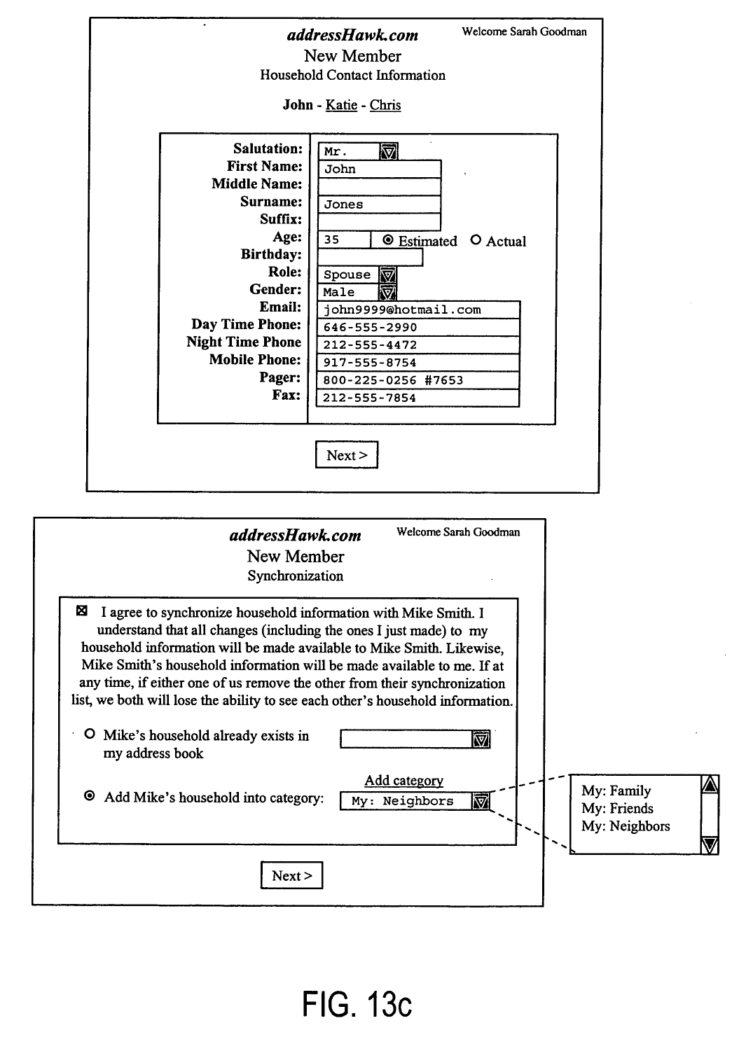

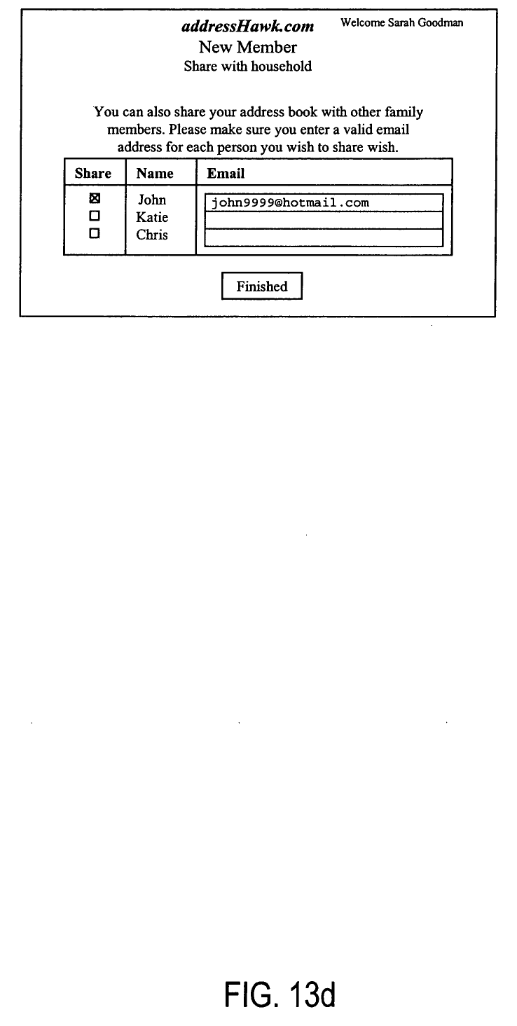

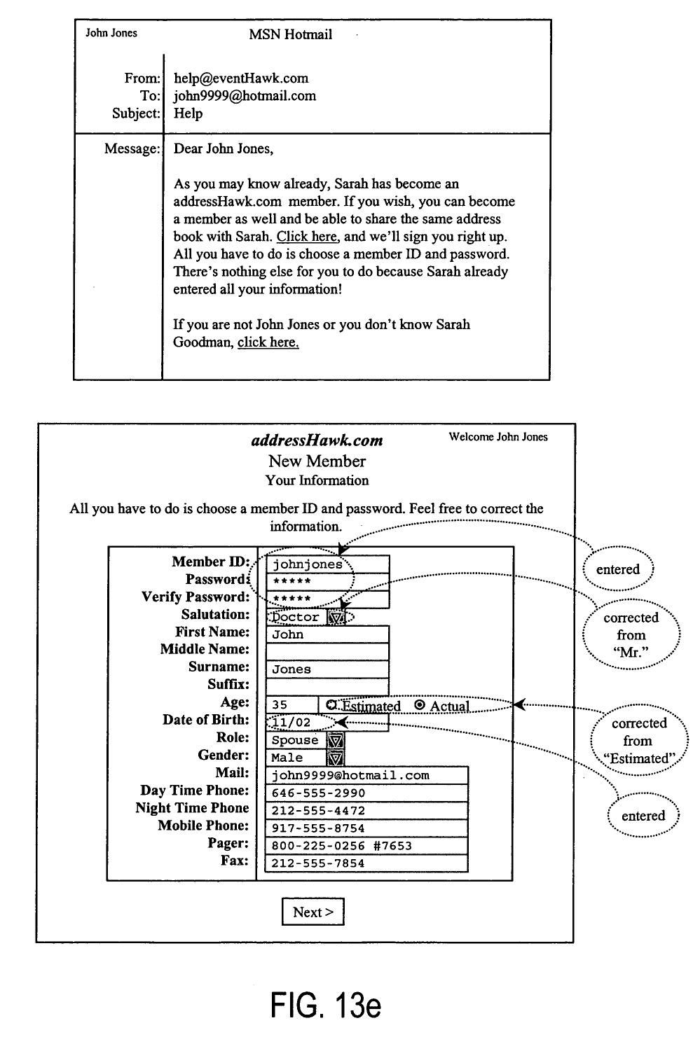

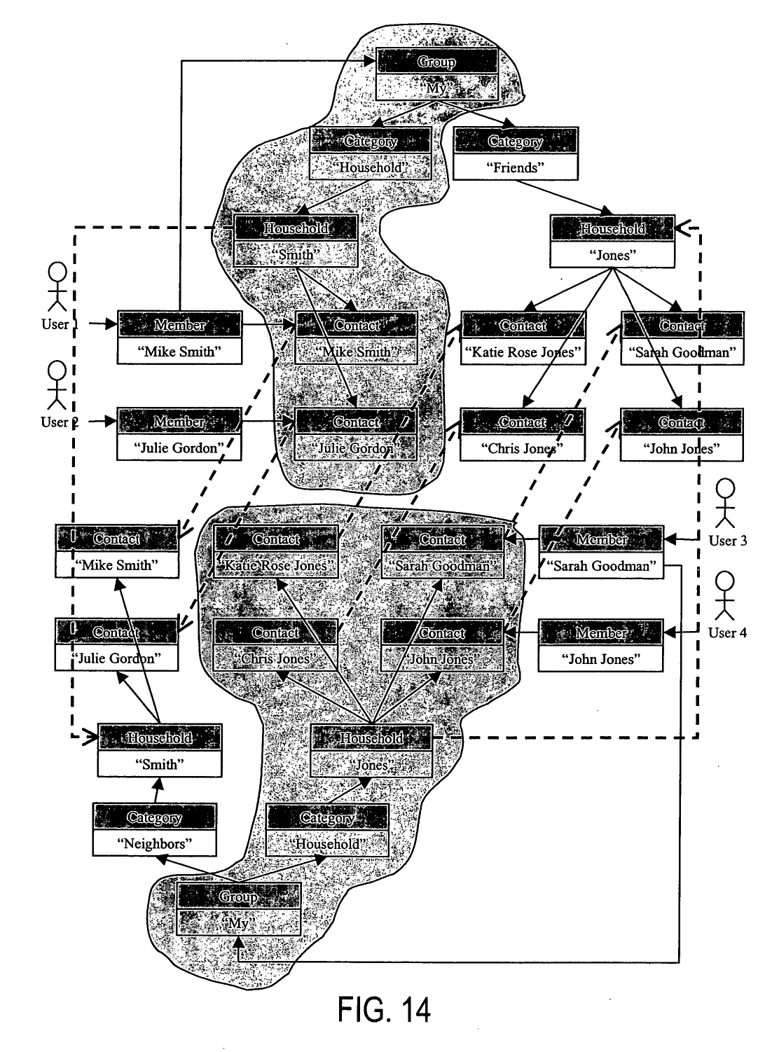

Typically people become members by signing up and entering all their household information (not shown). Another way for people to become members is by receiving an email request (FIG. 13a) in which a family, friend, or college contact asks them to verify their household information so their contact can plan their wedding or other event. When the contact clicks on the hyperlink (“click here”) they are transported to the addressHawk.com website. As will be appreciated by those skilled in the art, there is a URL-embedded code in the hyperlink that allows addressHawk.com know to which person (Sarah Goodman) was referred by which member (Mike Smith). At this point, Sarah only has to enter a unique member ID and password, and correct any inaccurate information that Mike may have entered (FIGS. 13a-13c). When Sarah is finished correcting her information, she agrees to synchronize her information with Mike Smith. This means that both Sarah and Mike have to agree to let the other see their information. If Sarah decides to stop letting Mike Smith see her information, she will be restricted from seeing Mike's information as well. The benefit of this approach is that it encourages people to be open with their information because that is the only way they can get the benefit of seeing other people's updated information (which in turn saves them time.) The next screen (FIG. 13d) allows Sarah to get her husband John Jones to become a member. At this point Sarah is finished. Next, John Jones receives an email (FIG. 13e) and clicks on “click here” which transports him to the website. At depicted in FIG. 14, although Sarah is the owner of the household (it belongs to her group), John Jones can make changes as well. This is because all users from a given household can access and make changes to the household information (the gray area in the diagram.) This is an aspect of sharing which will be discussed later in greater detail.

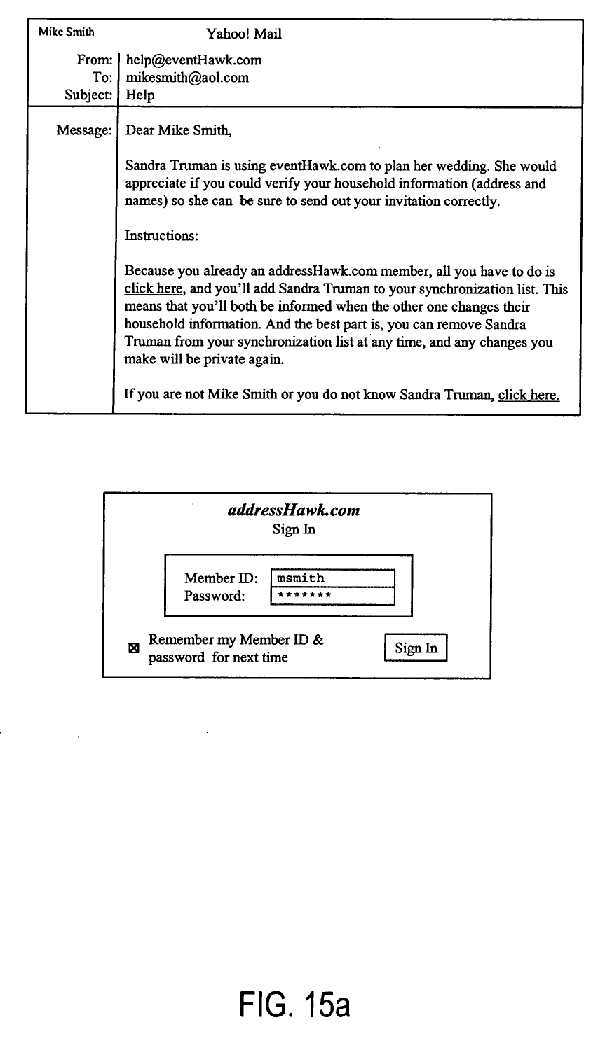

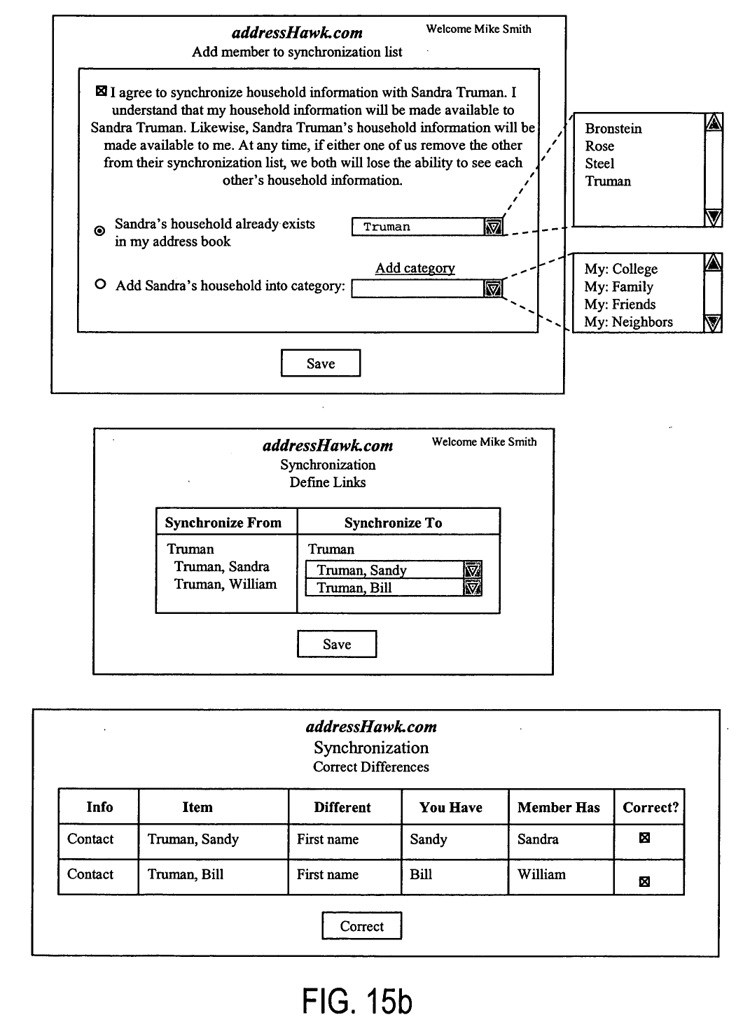

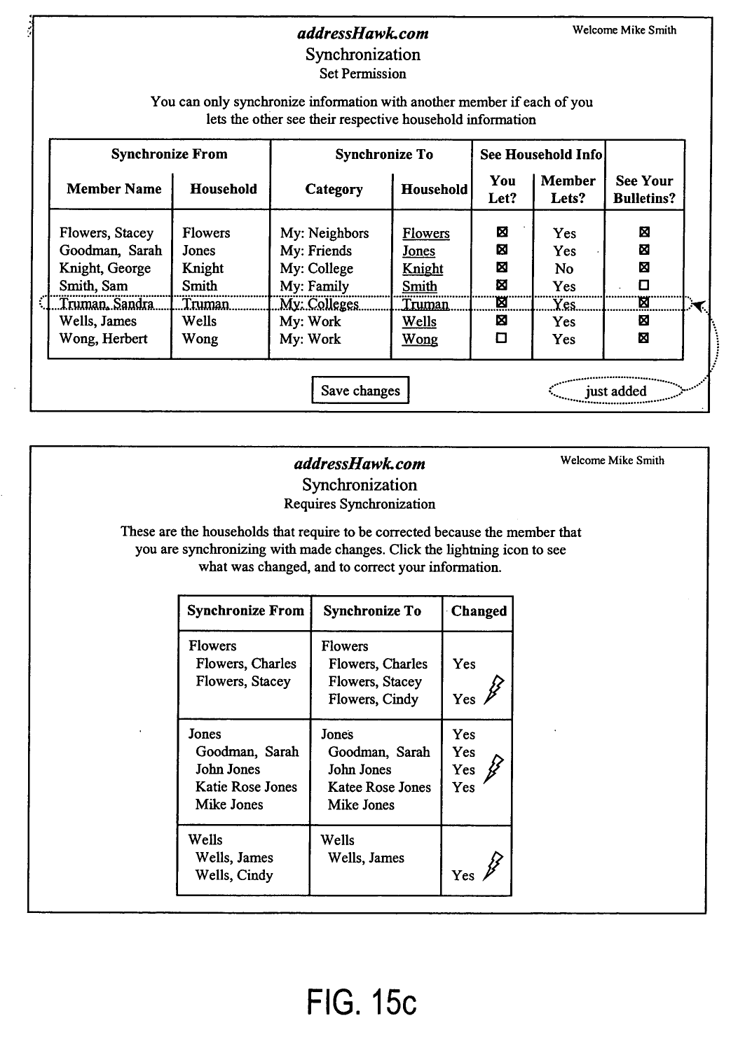

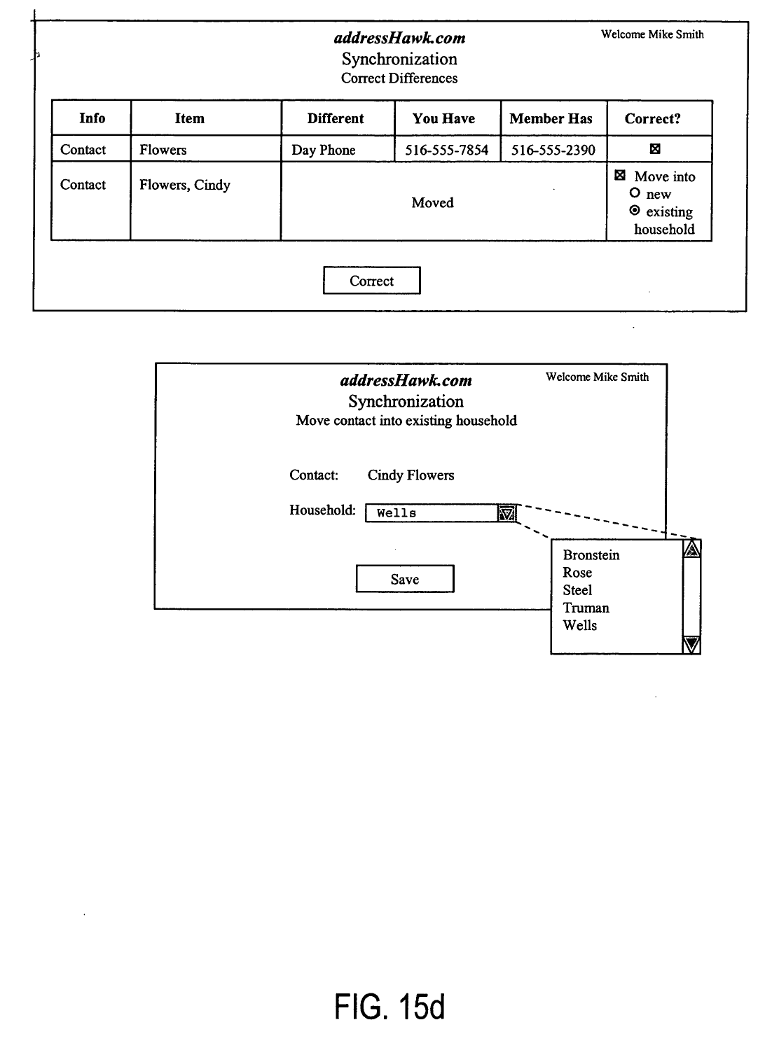

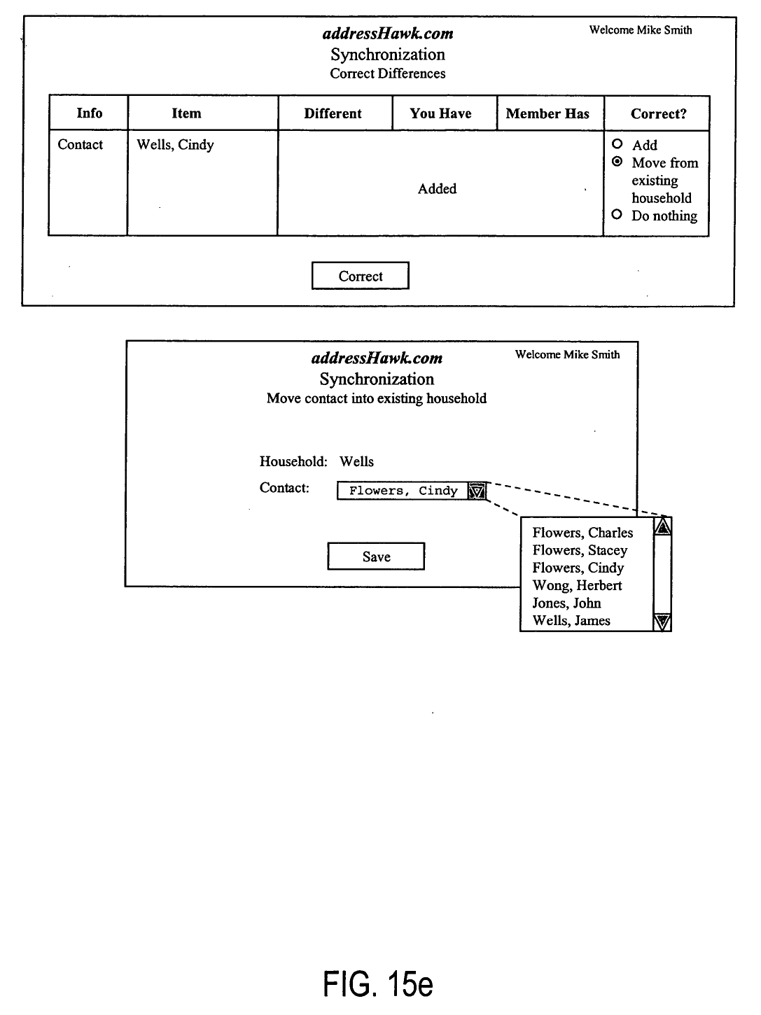

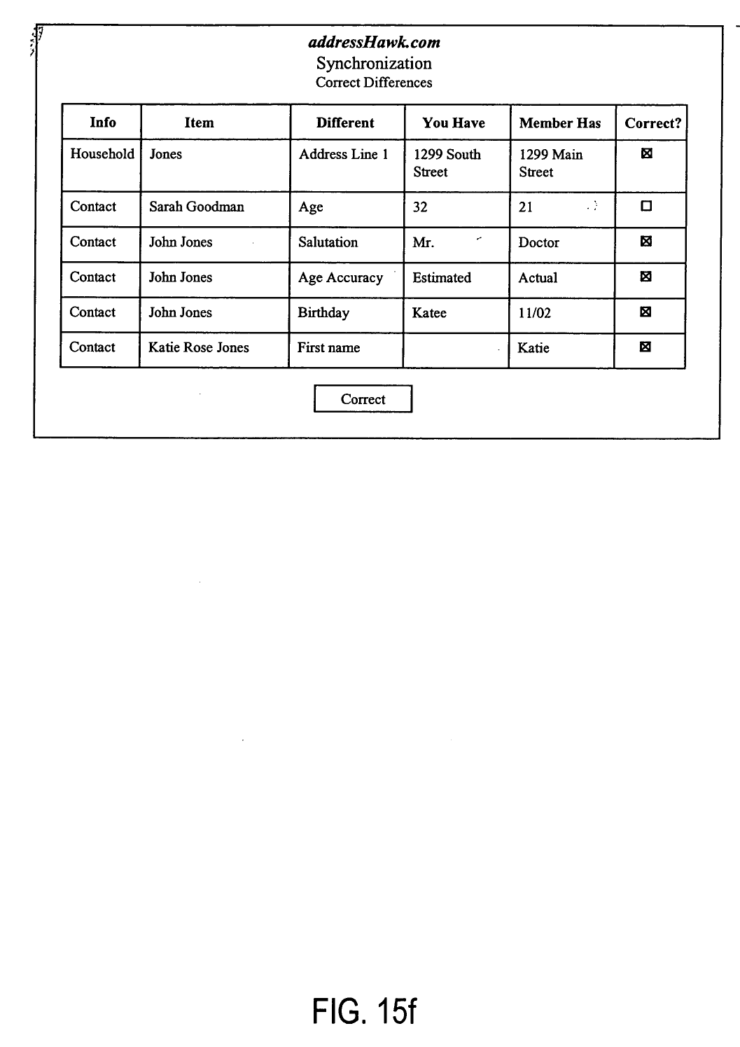

Once someone is a member, they may get requests from other people requesting that they synchronize information with them (FIG. 15a). In this example (FIG. 15b), Sandra Truman is the person making the request. However, Sandra already exists, and addressHawk.com allows Mike to select her preexisting information that was already entered without Sandra's knowledge and associate it to Sandra-the-member. The benefit is that Sandra's event-related information will not be split into two different “Sandra” records. In the next screen (Define Links”), Mike links Sandra's information into her own copy of Sandra's information. Notice how Mike entered Sandra's information differently, but is still able to associate them together. On the next screen, (“Correct Differences”) addressHawk.com displays the differences to Mike and allows Mike to choose what to correct. FIG. 15c shows the screen that contains all the members who Mike is synchronizing with. Notice that Sandra Truman appears on the list. On the next screen (“Requires Synchronization”) shows all the contacts that were changed. There are three basic types of changes. They are (a) a contact may be added to a household, (b) a contact may be removed from a household, or (c) the information in a household or contact can be changed. Notice how Cindy Flowers was removed from her parents household, and a Cindy Wells was added to James Wells household. This is an example of Cindy Flowers getting married to James Wells. Either Cindy can be moved into James Wells household by clicking on the top lighting bolt and specifying the household (FIG. 15d), or by clicking the bottom lighting bolt and specifying Cindy Flowers (FIG. 15e.)

Recall that Mike Smith synchronized information with Sarah Goodman (FIG. 13c) which Sarah corrected (FIGS. 13a-13b). In FIG. 15f, Sarah's changes are displayed to Mike. Notice that Mike does not have to accept all the corrections and that although Sarah changed her age to 21, Mike appropriately chooses not believe her, and does not accept that particular correction.

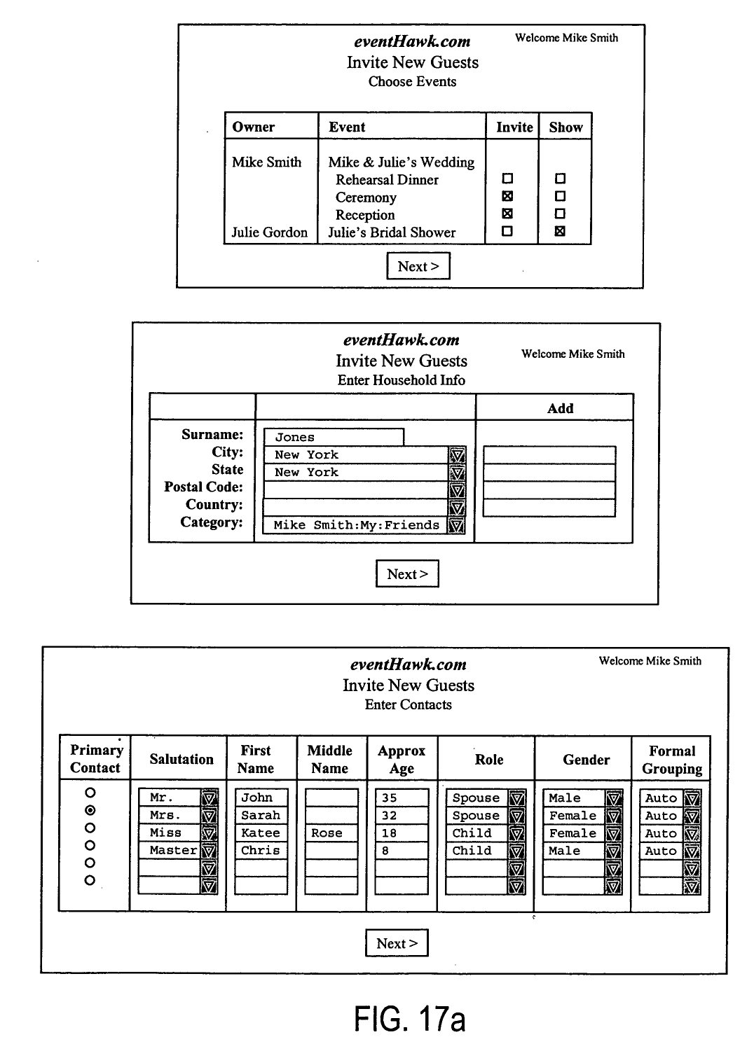

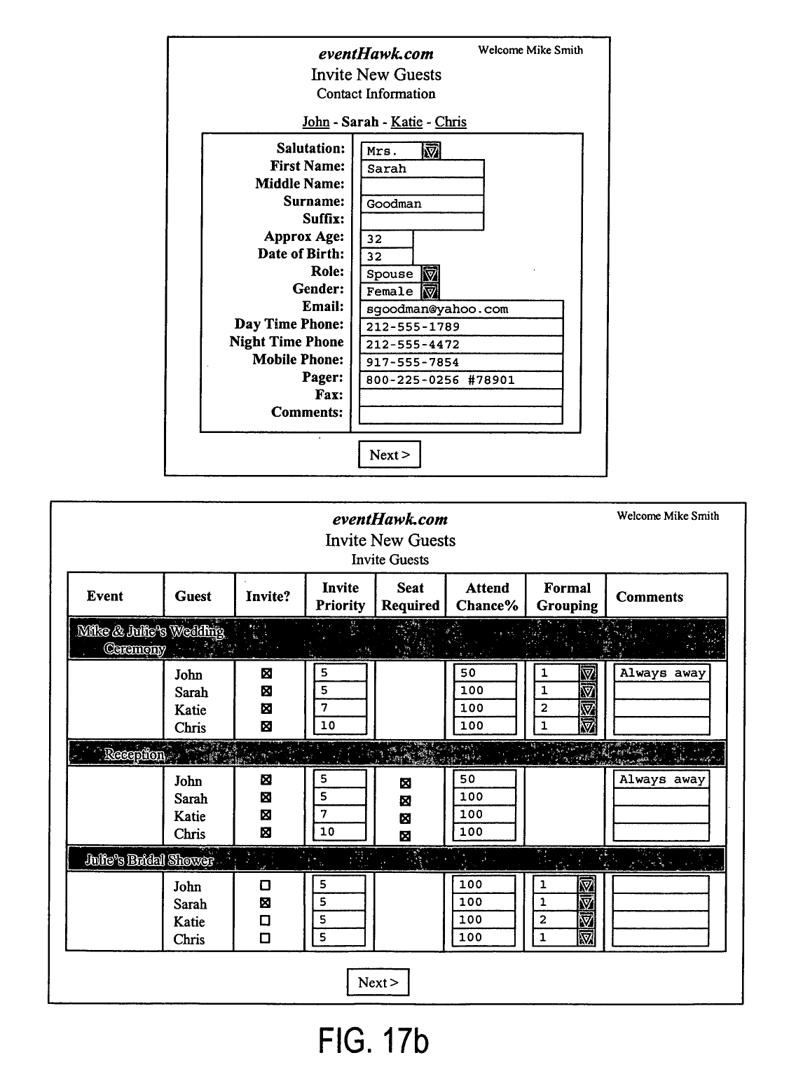

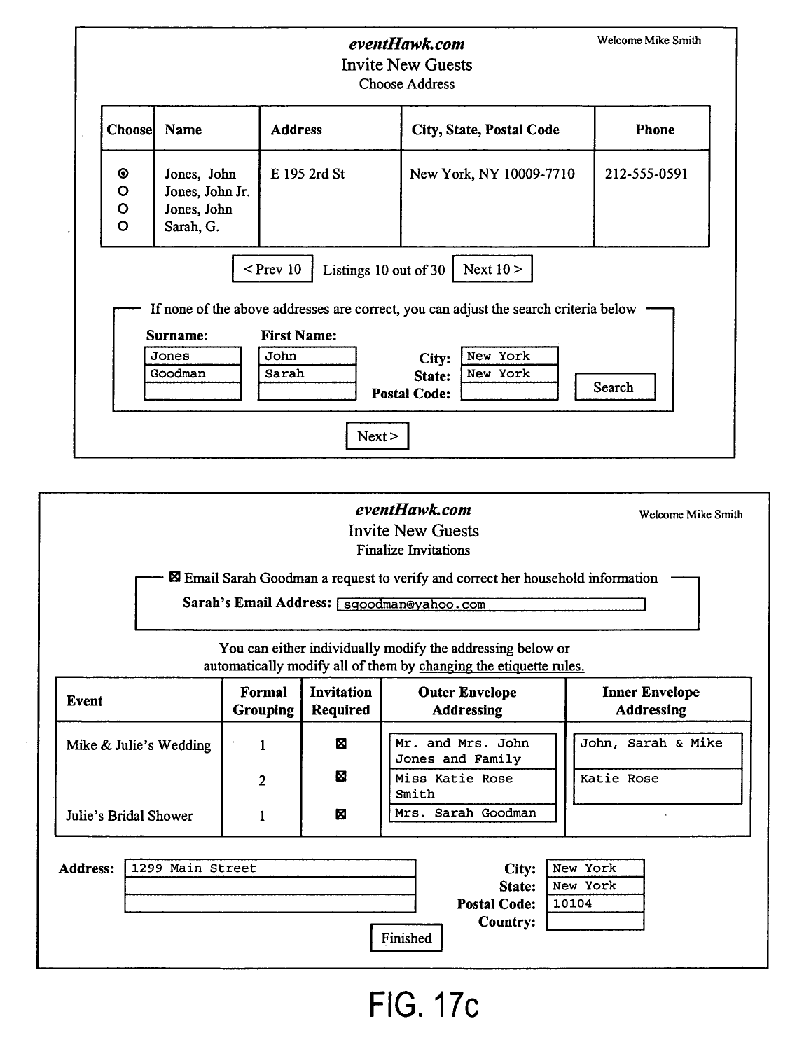

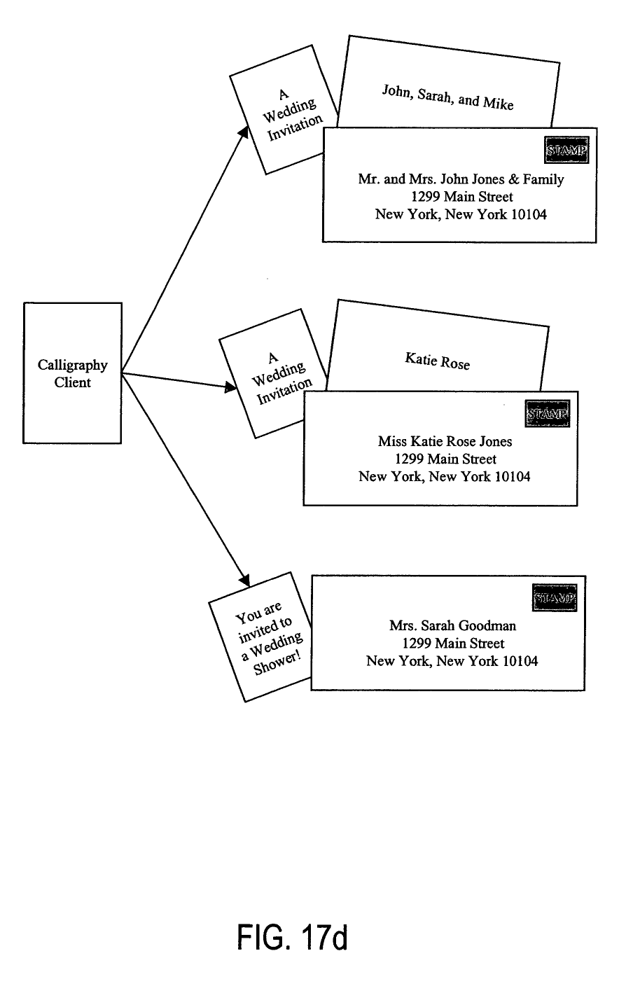

In addition to being able to synchronize information with other members, the address module also allows information to be searched and retrieved from the Internet (FIG. 17c) in screen “Choose Address”.

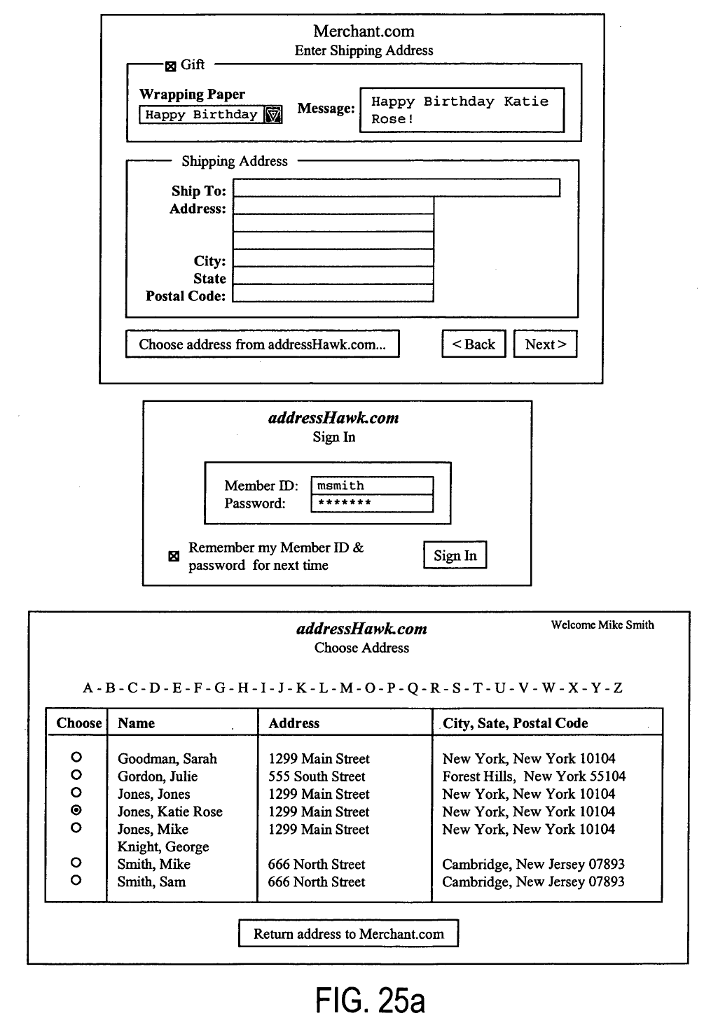

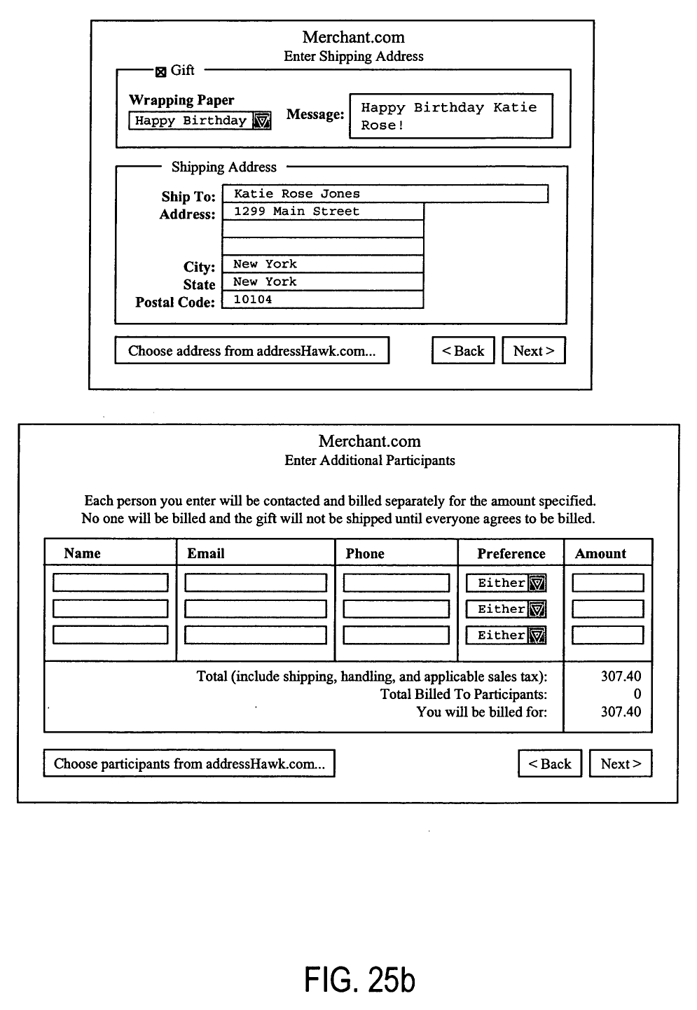

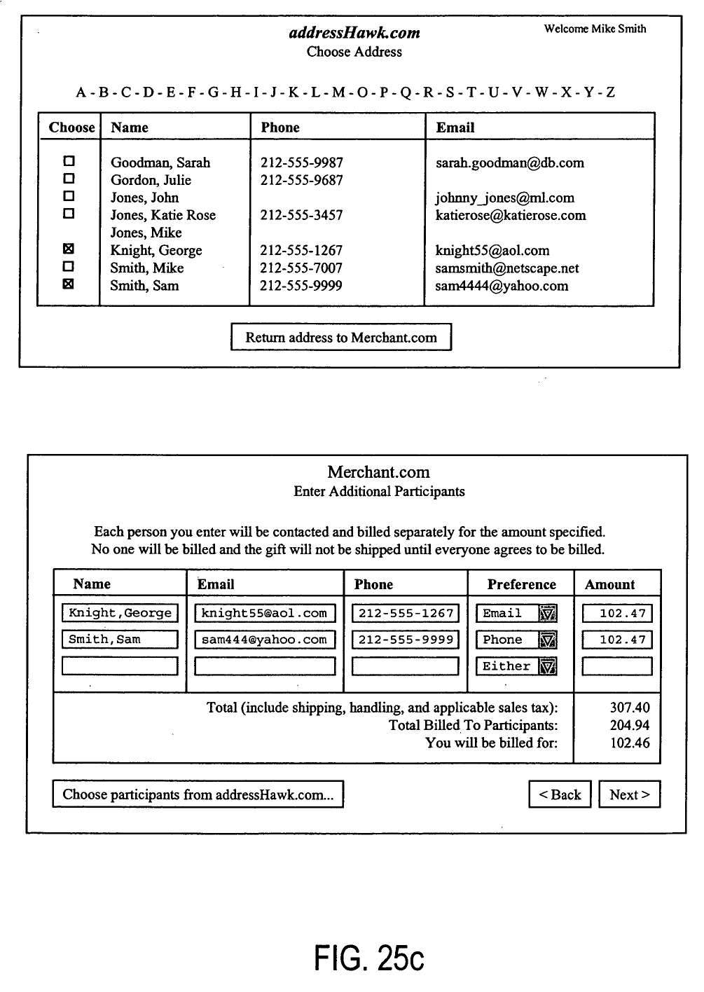

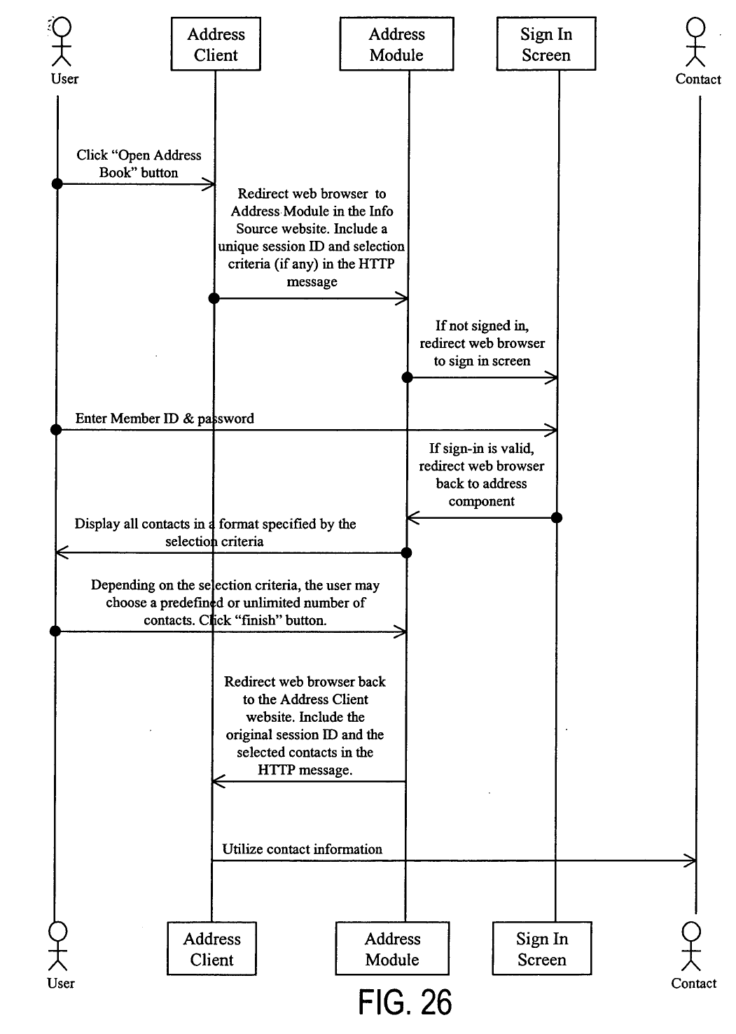

Another way to improve the accuracy of data is to give the users more incentive to maintain it by allowing it to be utilized in as many places as possible. For that reason, the address module has a function that allows the address book information to be utilized by any website or software program (“address client”). An example of this is detailed in FIGS. 25a-25c. In this example, Mike Smith is purchasing a gift for someone he knows from Merchant.com. First, Mike has to enter a shipping address for this person, which he does by clicking on the “Choose address from addressHawk.com” button. At that point he is transported to the addressHawk.com's website “Sign In” where he enters his member ID and password. At that point, Mike is able to choose the address from the “Choose Address” screen, and when he presses the “Return address to addressHawk.com” button, he is returned back to the merchant.com website (“Enter shipping address”) where the shipping address has been automatically filled in. Mike progresses to the next screen, where he can enter in people's names, email, and phone numbers for the purpose of having everyone participate in a gift. As shown in FIG. 25c, the vendors systems accepts data regarding all gift participants. The vendor may then bill each of them a pro-rata amount, the amount default to bill each participant equally, but being configurable. Next, Mike clicks the “Choose participants from addressHawk.com” button and is transported back into the next screen (“Choose Address”) in addressHawk.com. This time Mike did not have to sign in because addressHawk.com saved a browser cookie with a member ID and password from the last time he signed in. This time the “Choose Address” screen allows multiple contacts to be selected. FIG. 26 describes what is happening behind the screens. Not shown is that the address book may be fully customized to suit the needs of the client. In the proceeding example, because it was important that Mike selected a contact with an email address or phone number, the address book was configured to display the phone number and email address as well as restricting Mike from choosing contacts that did not have the requisite information. All information in the address book database can be used to filter, display, and restrict the contacts to fit the end-purpose that the information is needed for. A custom screen can be built to meet the needs of any client. The custom screen is deployed in the addressHawk.com website. The benefit of a custom screen is that the client can have full control of the presentation of the information for their customers without giving the client the information in the actual address book. The client can also customize the address book on the fly by passing parameters on the address book hyperlink. Also, although the example used is a website, a person skilled in the art will realize that a software based package will work in a similar fashion.

In addition to the address book being utilized by address clients, the present invention also includes two additional modules that utilize the user's address book for the direct benefit of the user. The first, the event module, also has the benefit that it will give users incentive to start using the present invention. Only when there are enough users using the address book will independent websites find it worthwhile to become an address client. The second, is the marketing module which also has the benefit that it will align websites to encourage their customers to become addressHawk.com users.

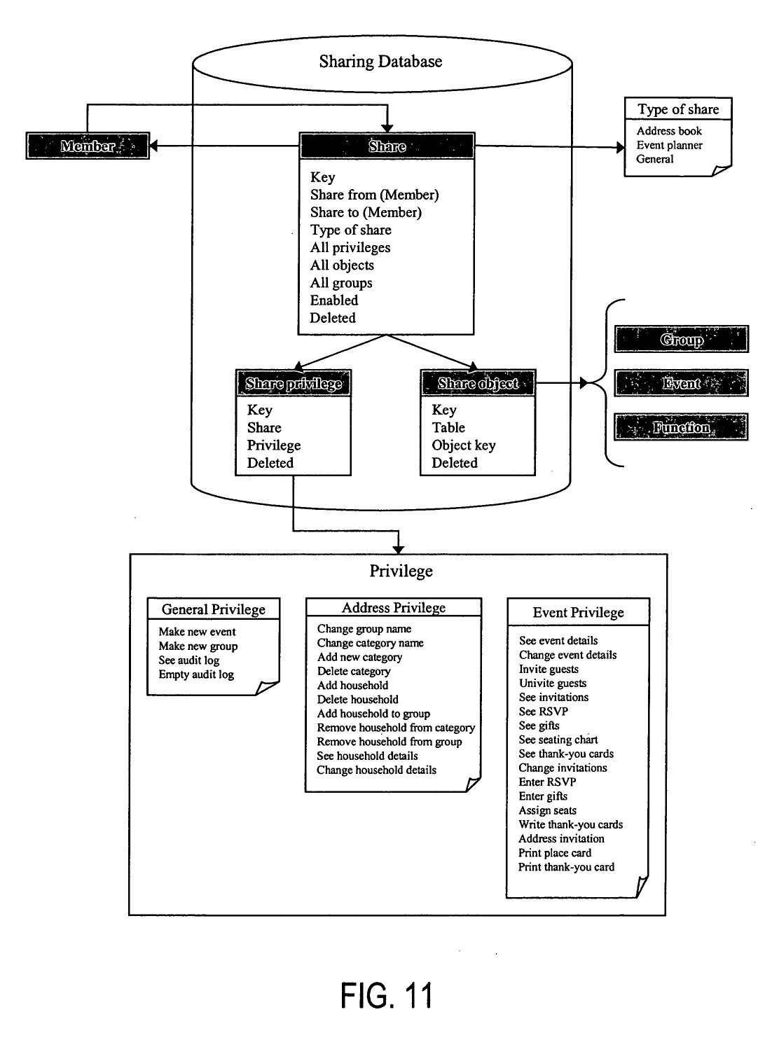

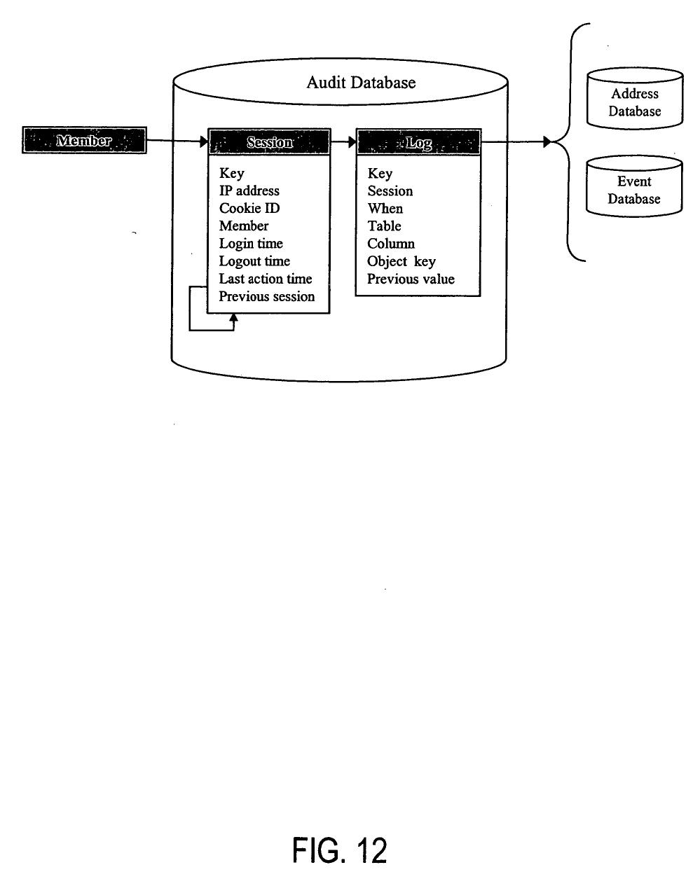

As mentioned earlier, the address book can be shared between users. This is another function that improves the accuracy of the data, because more people are using and relying on the same information. FIG. 11 shows the sharing database. The Address Privileges lets the “owner” share their address book with other users, and to define exactly what the other users has permission to do. As mentioned above, there is an automatic share for users in the same household that they have full permission on it (except that no one can change the permanent “My” group and “Household” category.)

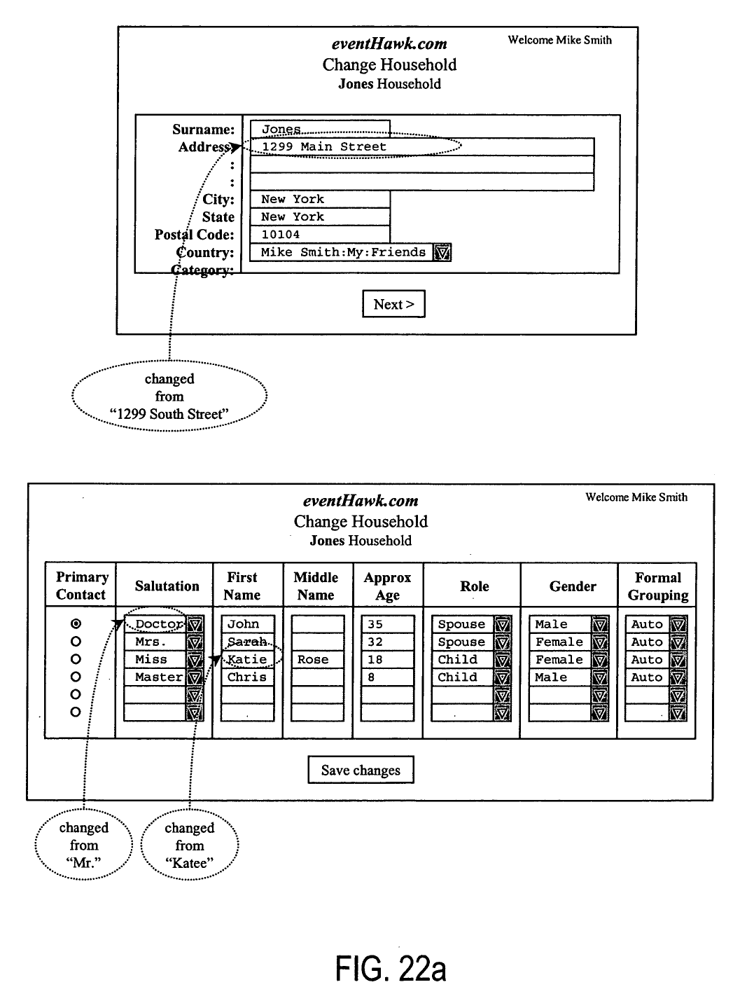

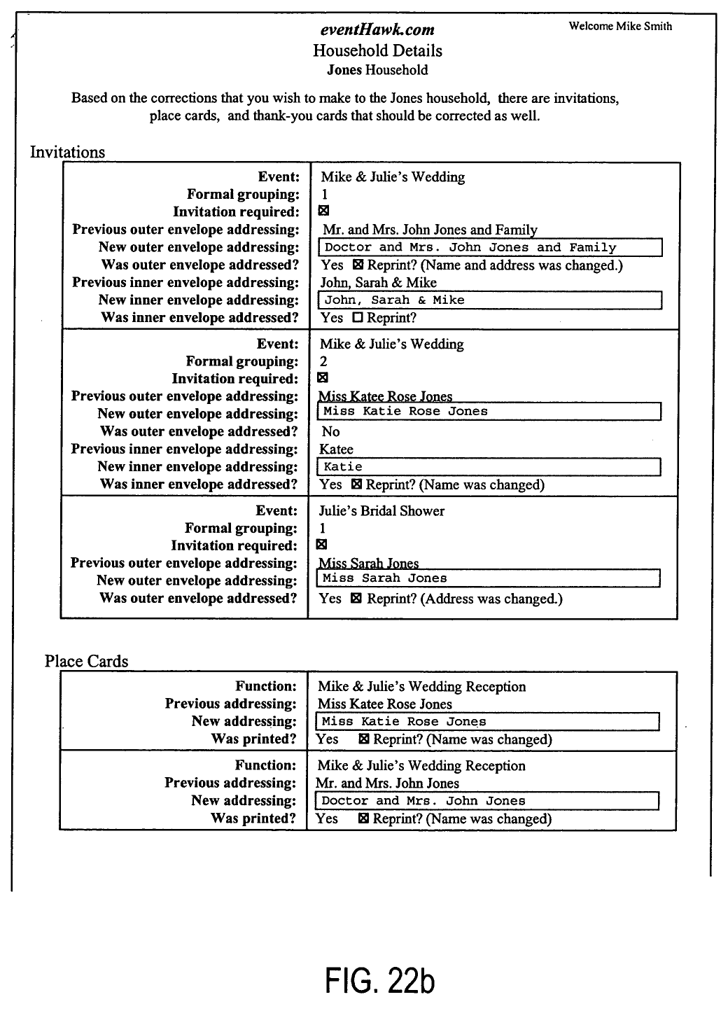

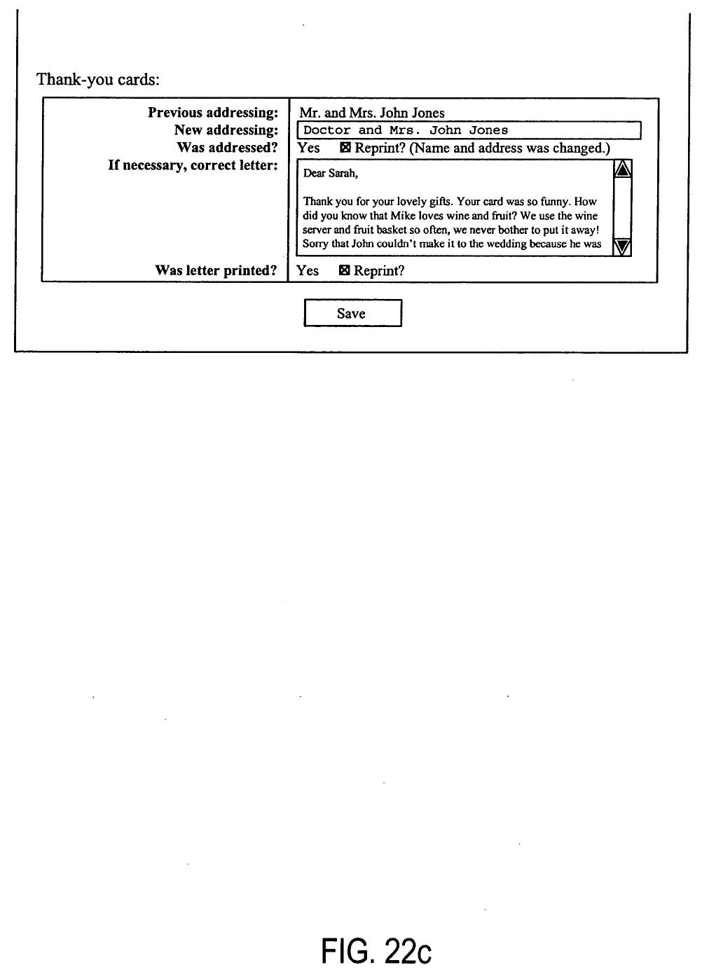

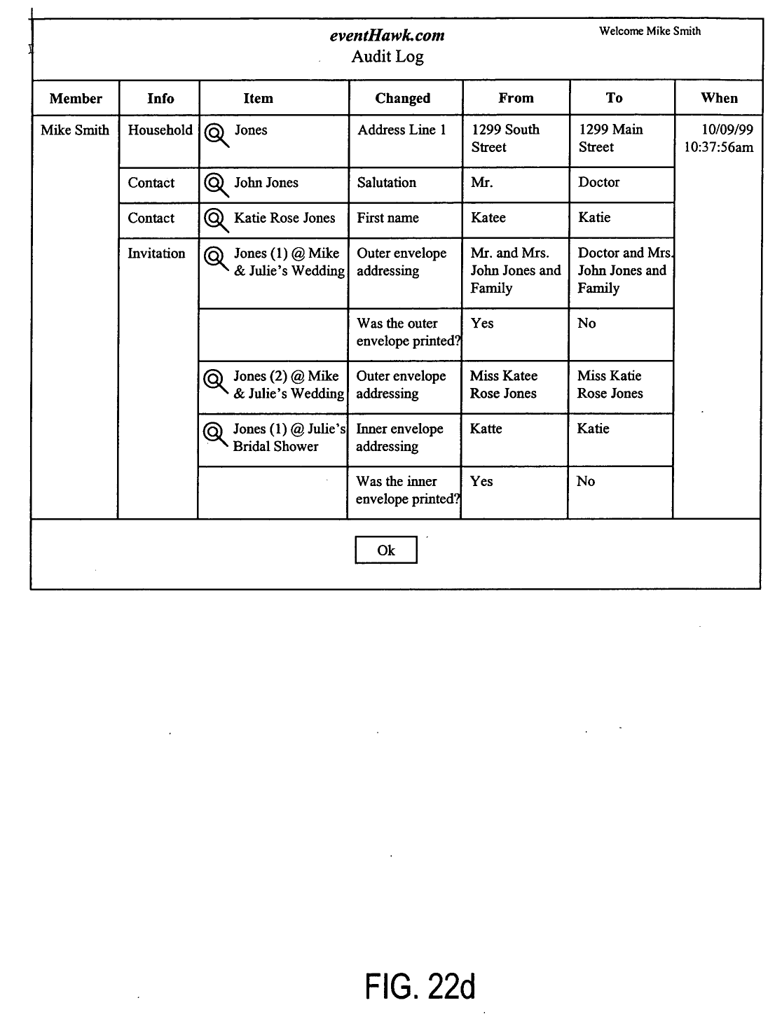

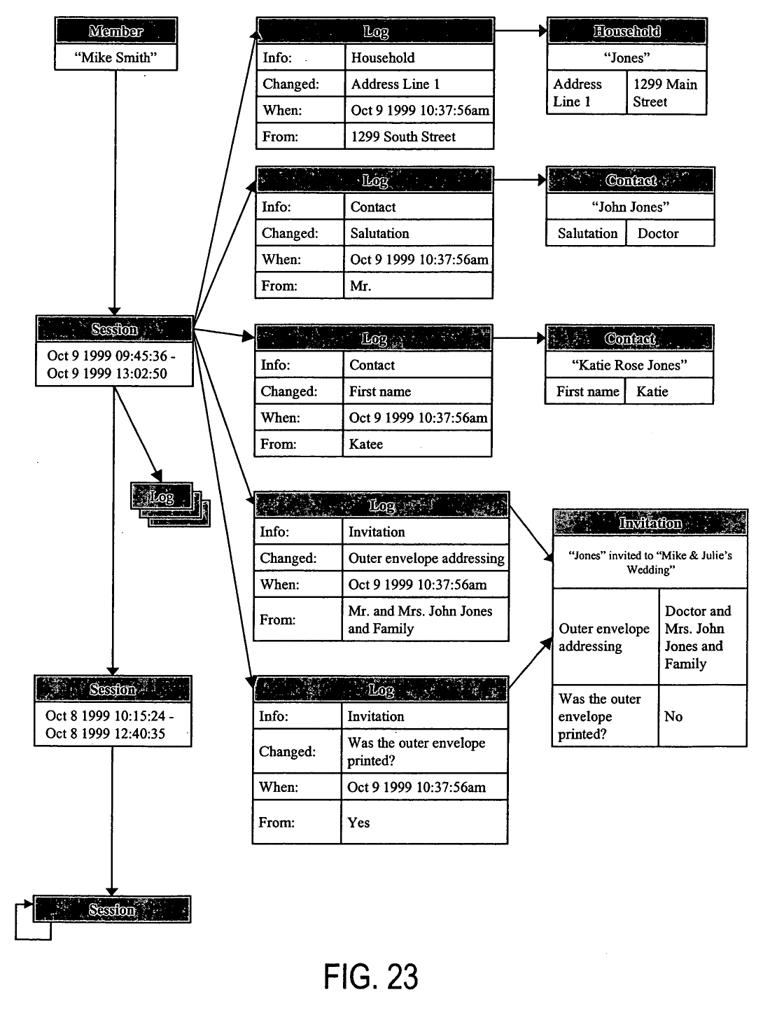

Yet another function that improves the accuracy of the address book is the fact that all changes are recorded in an audit log. Regardless if users made the changes themselves or if someone the user shared the information with makes the changes, everything is recorded in the audit log, as depicted in FIG. 22. By allowing users to research who changed what, the person that made the changes is held accountable and will take extra time to be accurate.

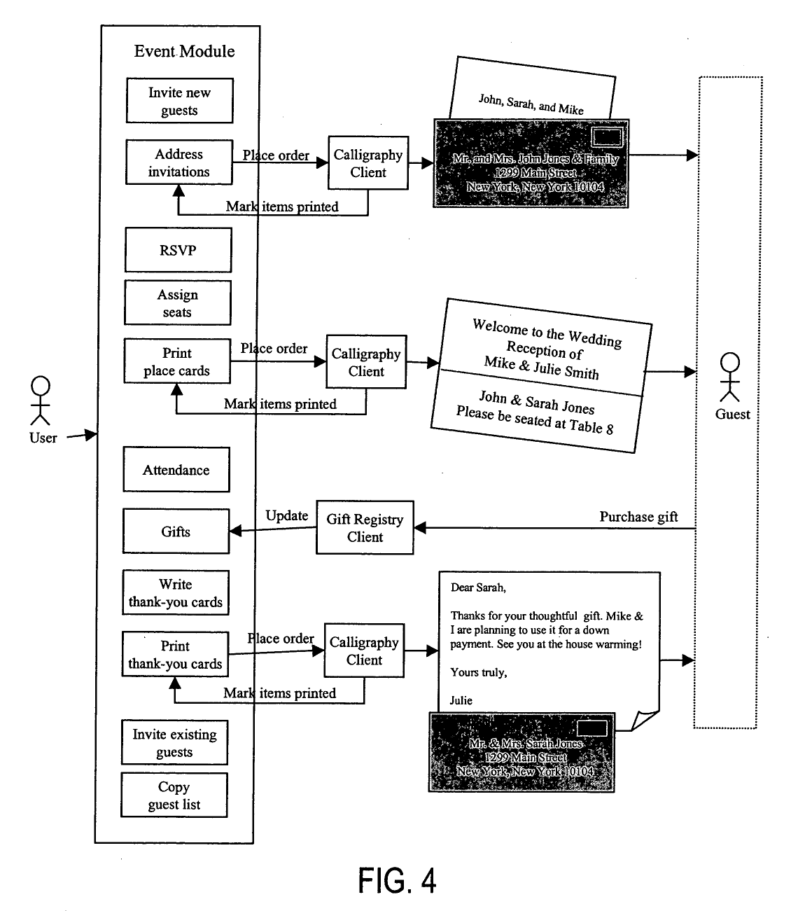

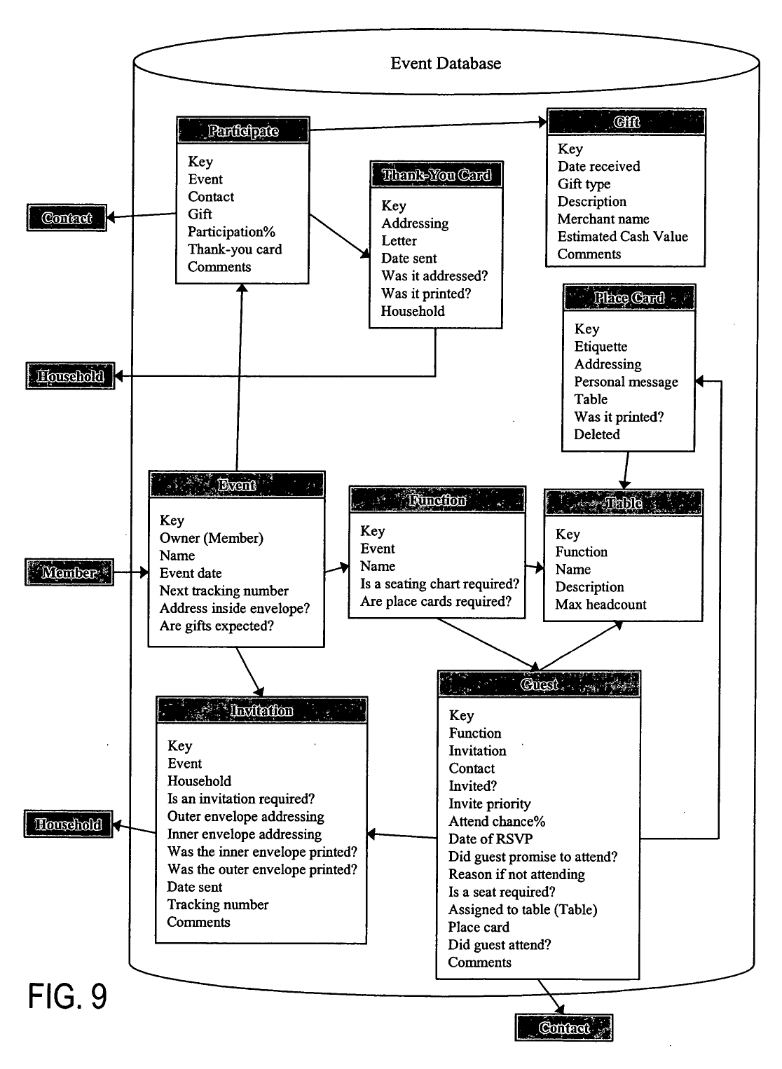

FIG. 4 illustrates the primary functions of the event module. FIG. 9 illustrates the database used by the event module. For some functions, there may be a sequence of screen that demonstrate the functionality being used.

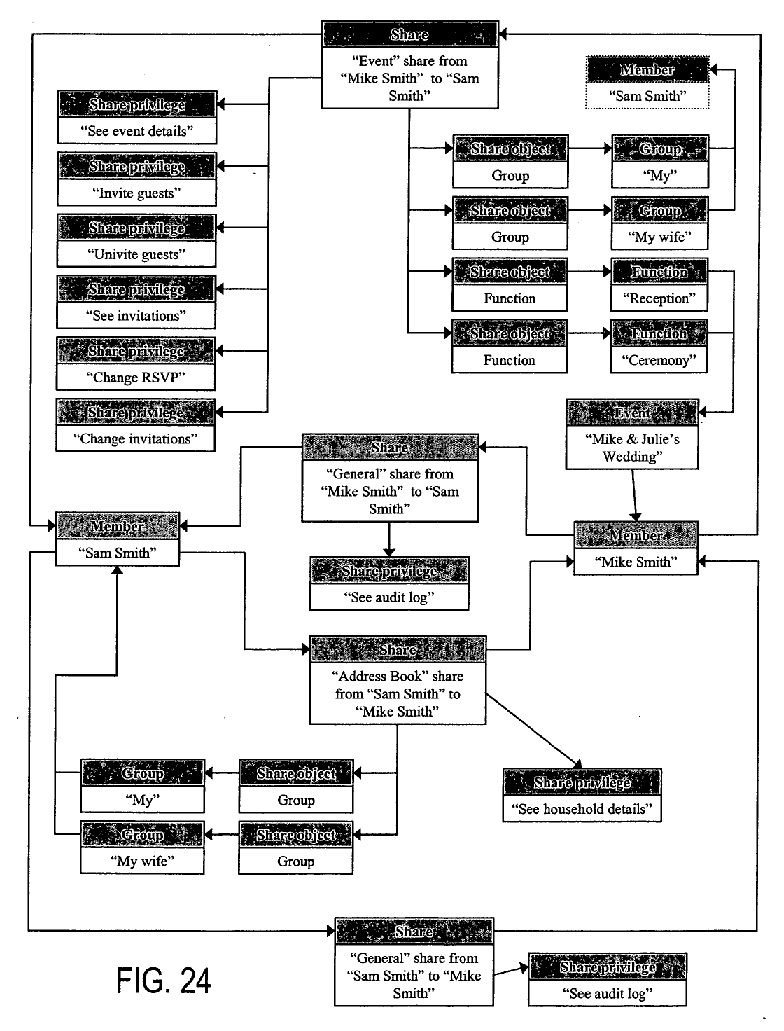

The over-all goal of the event component is to make event planning easier. One of the ways the present invention accomplishes that goal is by providing a sharing function that allows users to plan an event together. This function leverages off the sharing function discussed in the address section, and goes further by allowing the events information to be shared as well. FIG. 11 shows the sharing database. The Event Privileges lets the “owner” of an event share it with other users, as well as define exactly what the other users has permission to do. FIG. 24 is an example of how two user are sharing information with each other. Notice that all three types of shares are depicted (address book, event, and general). Also notice how shares are specific to the information and privileges that are assigned. With proper use of sharing, users can invite other user's contacts as guests to an event, or a user can get help planning an event.

Another way that the present invention makes event planning easier, is by storing the event information in a central repository that allows users to plan their event from any location as long as they have a browser, a computer, and an Internet connection.

Yet another way that the present invention makes event planning easier, is by providing a function that automates the time-consuming process of addressing and writing invitations, place cards, and thank-you cards (“documents”). The event module handles documents from start to finish and attempts to make the process as automated as possible. To start, the event module utilizes the household information from the address database. This means that the information will be as accurate and up to date as possible, which means that there's less of a chance that documents will need to be re-addressed and re-written. Next, the event module allows documents to be addressed and written by an independent calligraphy client. Or, the user can utilize the Event Privileges (“Address invitations”, “Print place cards”, “Print thank-you cards”), to let a friend or family member hand write it on their behalf. The calligraphy client may provide hand or computer calligraphy. In the case of the hand calligraphy, it may take a relatively long time for the calligrapher to finish. For that reason, the event module provides the a function that the calligraphy client marks the article as printed right before the article is printed (calligraphers can choose a specified number of documents to print, and the event module will mark those documents as printed and then print it for them to hand write on to the document.) For computerized calligraphy clients, the address module will provide an document one at a time to the calligraphy client. The document will be marked as printed right before it is handed over to the calligraphy client. If an document is changed after it is marked printed, the user is given the option to mark the document as unprinted. With this function in place, the hosts planning an event will be able to communicate changes with the calligraphers up to moments before the event without worrying that a change may fall through the cracks. As soon as a user places an calligraphy order to a particular calligraphy client, the calligraphy client will be only allowed to access the user's information that is necessary to complete the job and to update the printed indicator for each document printed. FIGS. 22a-22d is an example of a guest's address changing which causes the associated documents to be reprinted.

Yet another way that the present invention makes event planning easier, is by allowing guests to be invited to multiple events at the same time as well as adding them into the address book. This example is depicted in FIGS. 17a-17d. Starting with FIG. 17a, in the “Choose Events” screen, Mike choose to invite guests to the ceremony and reception functions for Mike & Julie's Wedding. Julie's Bridal Shower is selected “show” which means that the event will be displayed, but guests will not be invited to it by default. Continuing to the next screen, “Enter Household Info”, Mike enters in the information he knows about the Jones household. He continue with the next screen “Enter Contacts” and enters in the contact information. All information is self explanatory, except for “formal grouping” which will explained later. In the next screen “Contact Information” Mike enters even more information about each contact. In the following screen, “Invite Guests”, Mike enters exactly who will and who is not invited to every event and function. The “Invite Priority” is used to let the user reduce the number of guests if there are too many. The user simply lists the invited guests in priority order, and anyone who falls out in the bottom is a good candidate to get cut from the event. “Attend Chance” is used in conjunction with “Invite Priority” to help a user decide which guests to cut. Effectively, if two guests both have a 50% chance of coming and two guests have a 75% chance of coming, the 50% guests can be considered 1 guests on the list, but the 75% guests can be considered as 1.5 guests on the list. The “Invite Priority” is also used for seating purposes, in case a user wants to overbook a table, the user will assign two 50% guests to the same table and assume that there's only one guests assigned to the table. The “Invite Priority” and “attend Chance” numbers are subjective and are only understood in the context that the user who entered them in the first place understands them. In the next screen “Choose Address”, the Internet is automatically searched for the guests mailing address and phone number. In the next screen, “Finalize Invitations”, the user can email Sarah Goodman a request to verify and correct her household information that the user just entered. (the email is depicted in FIG. 13a and was discussed in detail in the address section.) Also, in this screen the user can verify what the outer and inner addressing will look like. When an event is created, the user selects the etiquette rules that control how the names are grouped together when addressing an invitation. The inner and outer envelopes usually have different etiquette rules. Katie Rose is getting her own invitation because of the way the etiquette rules were set. More will be discussed about the etiquette rules when place cards are discussed. At this point the invitations can be addressed (FIG. 17d) by the calligraphy client and mailed. It is important to note that some formal invitations have an outer and inner envelope, and that the event database has a separate printed indicator for both. (Not shown is the tracking number which is optionally printed on the outer envelope.)

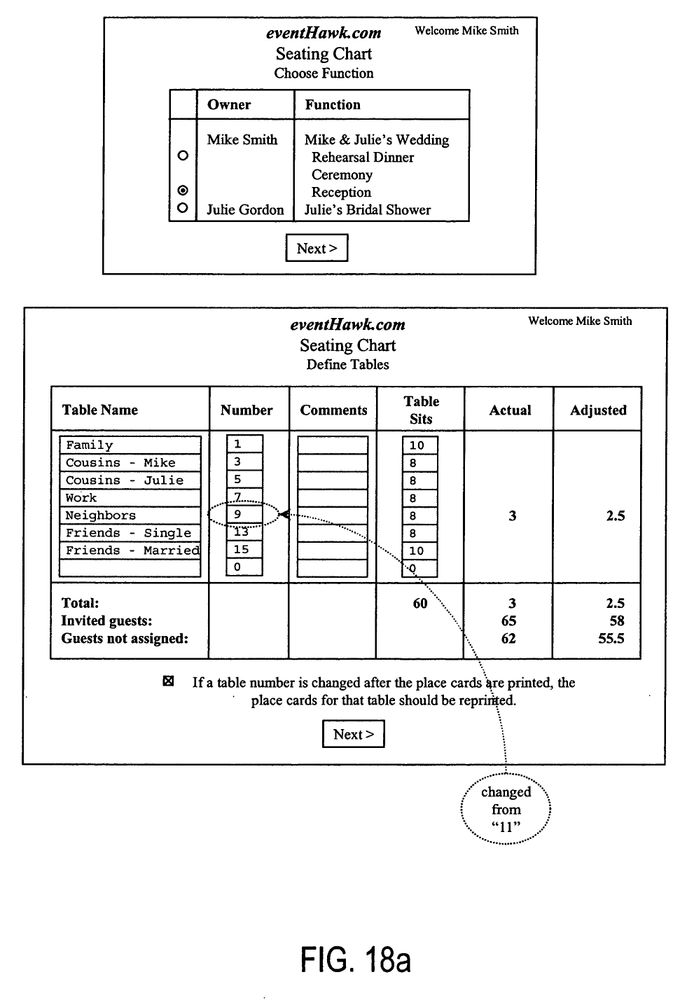

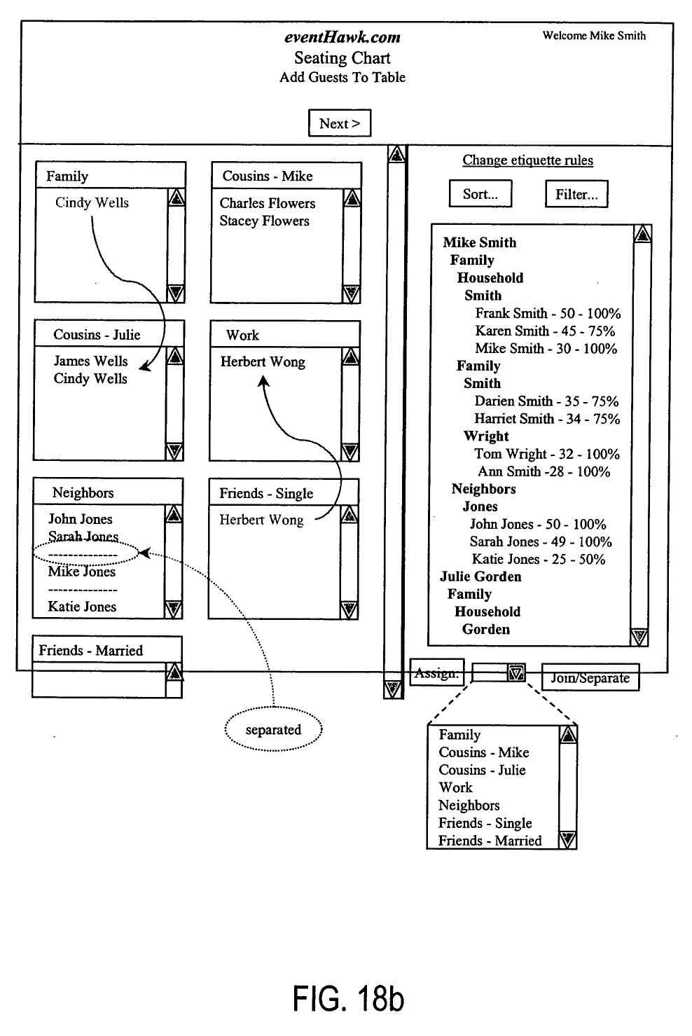

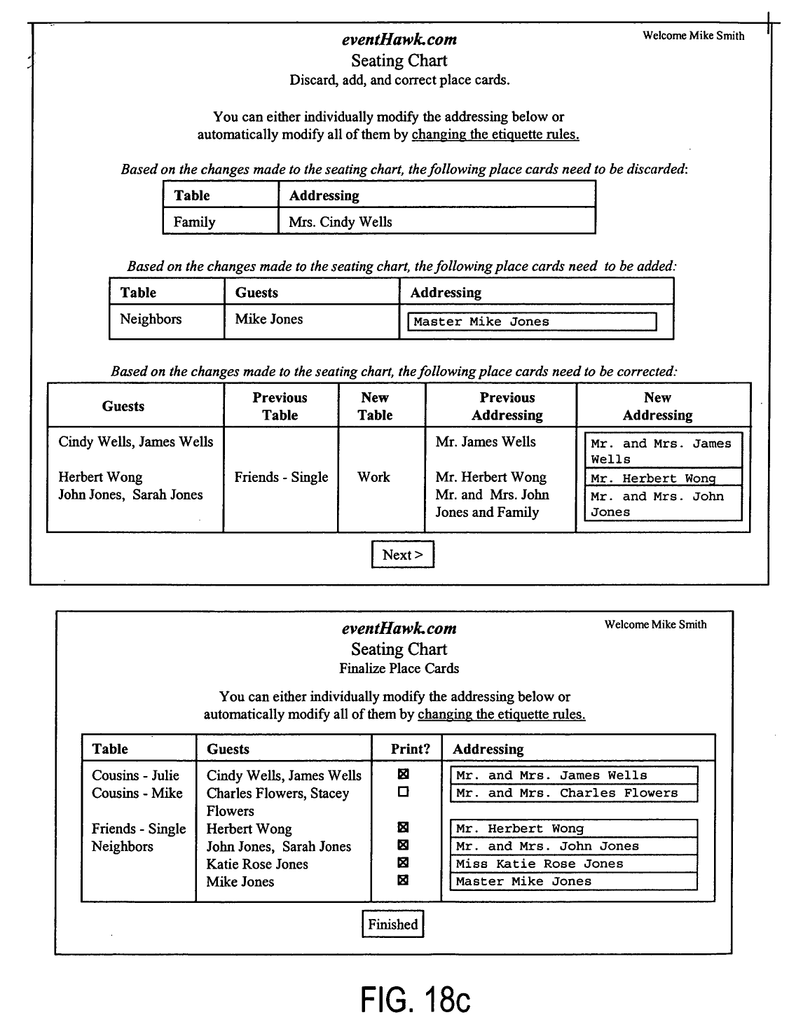

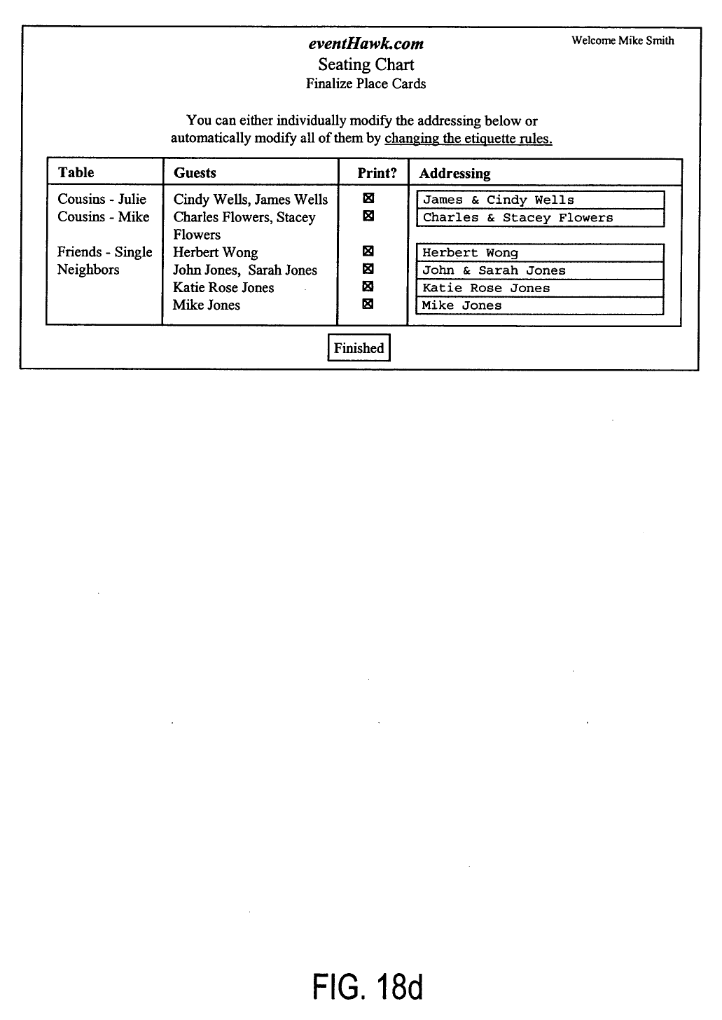

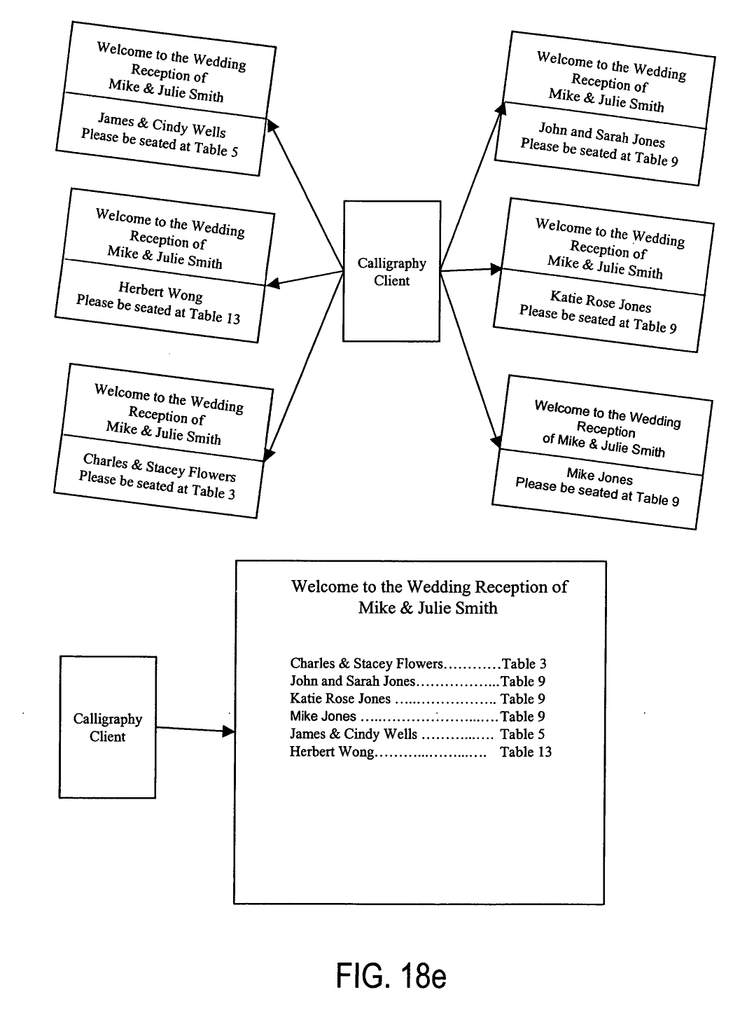

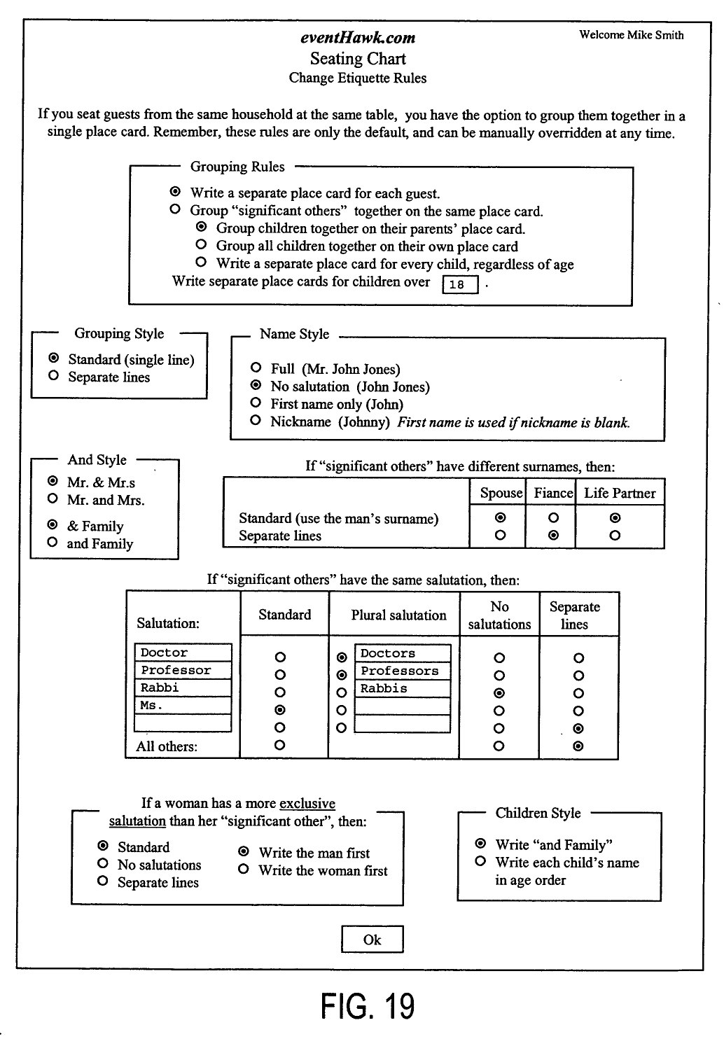

Yet another way that the present invention makes event planning easier, is by allowing RSVP to be entered for guests. Based on the RSVP information, a user can create a seating chart, which in turn allows the user to print out place cards. In FIGS. 18a-18e, Mike Smith is makes some changes to his wedding reception seating chart. In “Choose Function”, Mike chooses his wedding reception. In the next screen “Define Tables”, Mike changes the table number. Notice the checkbox at the bottom of the screen that instructs the event module to reprint all place cards for a table when its number is changed. In the next screen “Add Guests To Table”, a number of changes has been made. First, Cindy Wells was moved from “Family” to “Cousins—Julie”. Second, Herbert Wong was moved from “Friends—Single” to “Work”. Also, a separation was added in between Mike Jones and his parents. A separation (the-----line) is usually generated by the event module based on the etiquette rules. However, sometimes there is a special case where a user may want to give a guest their own place card, and in that case the user will click on the “separate/join” button to either add or remove a separation. In this example, no additional guests were assigned seats. Mike continues with the next screen, “Discard, add, and correct place cards”, in which all the changes that was made to the seating chart is reflected into place cards. First the discarded place cards are shown. That usually happens when two guest who are “significant others” are placed on different tables and then assigned to the same table. In that scenario, one of the place cards has to be discarded (if it was printed.) If the place card wasn't printed yet, the event module just removes it behind the scene. Next, the added place cards need to be verified. Next and last, the changed place cards are shown. That typically happens when either all the guests on a place card are moved in unison to another table, or guests that are grouped together or added or removed from a table. Proceeding to the next screen, “Finalize Place Cards”, all the current place cards are displayed so that the user can insure that all the place cards have the same consistent style. At this point if the user clicks on “change the etiquette rules”, the user will be shown the screen as depicted in FIG. 19. This screen allows the user to customize the etiquette rules so that when guests are grouped together on a place card, it is done consistently. The etiquette rules also take into account modem etiquette issues such as same-sex couples and couples that the wife has the same or better professional salutation. These rules are confusing for people to remember and to know what their options are. The etiquette rules also allow the user to dictate when guests should be grouped together in the same place card. In this example, Mike adjusts the etiquette rules, and the result is depicted in FIG. 18d. Notice how the addressing went from a formal to a casual tone automatically. In FIG. 18e, the calligraphy client can print out the place cards in two different ways. Either the place card is printed individually on small pieces of paper, or a seating scroll can be created, in which each group becomes a single line on the seating scroll.

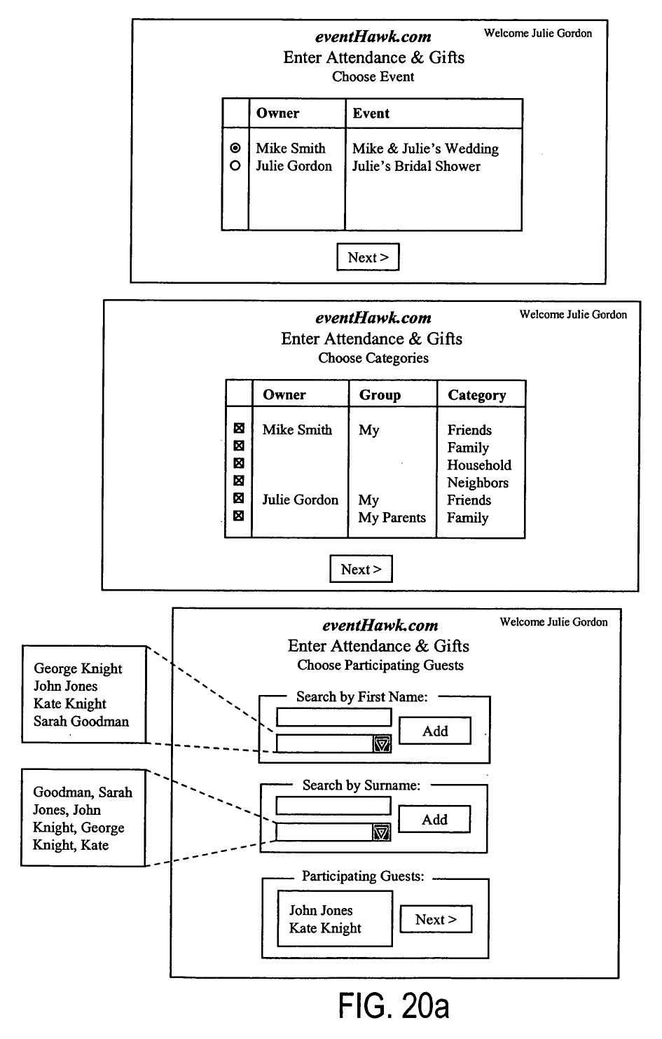

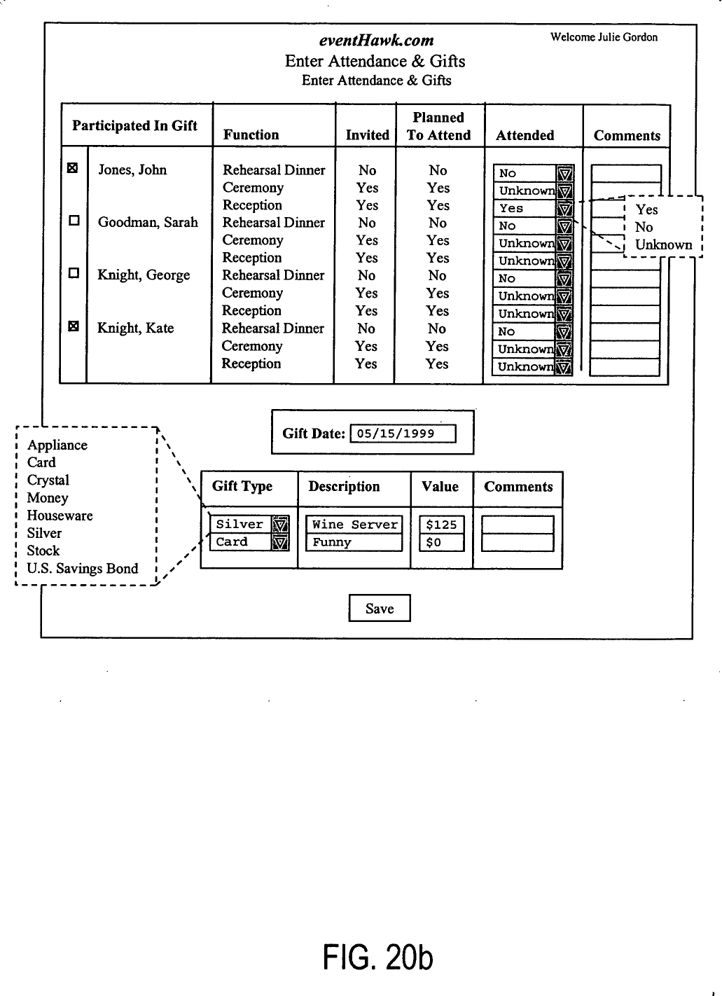

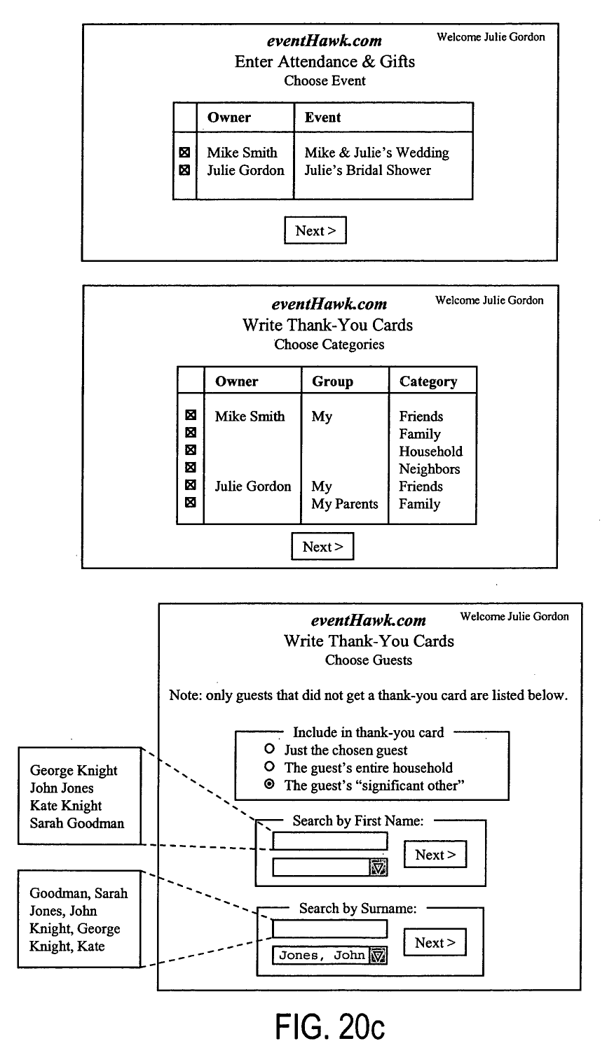

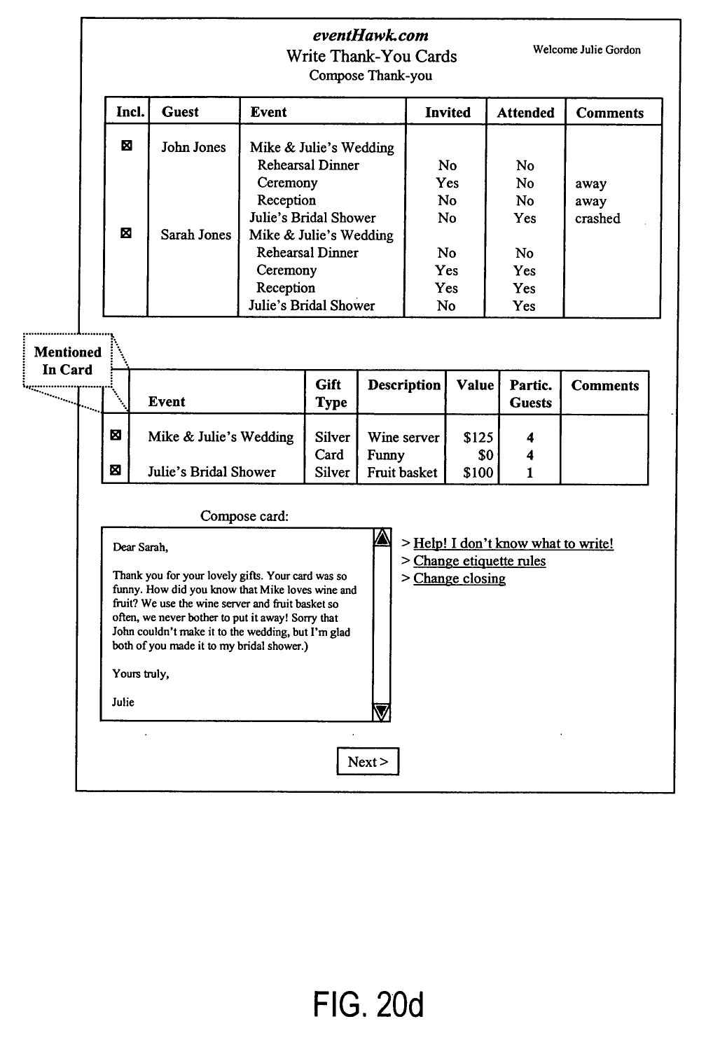

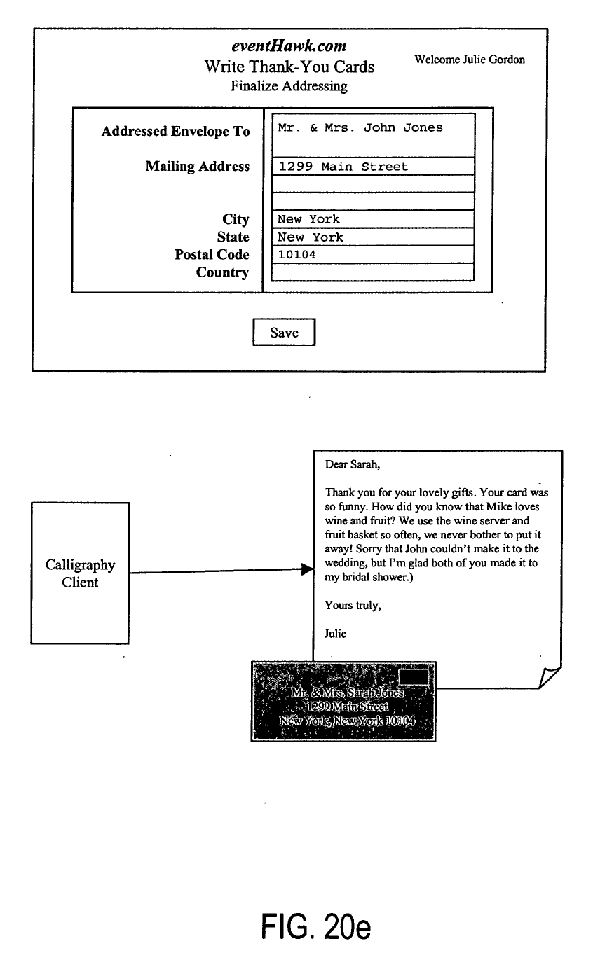

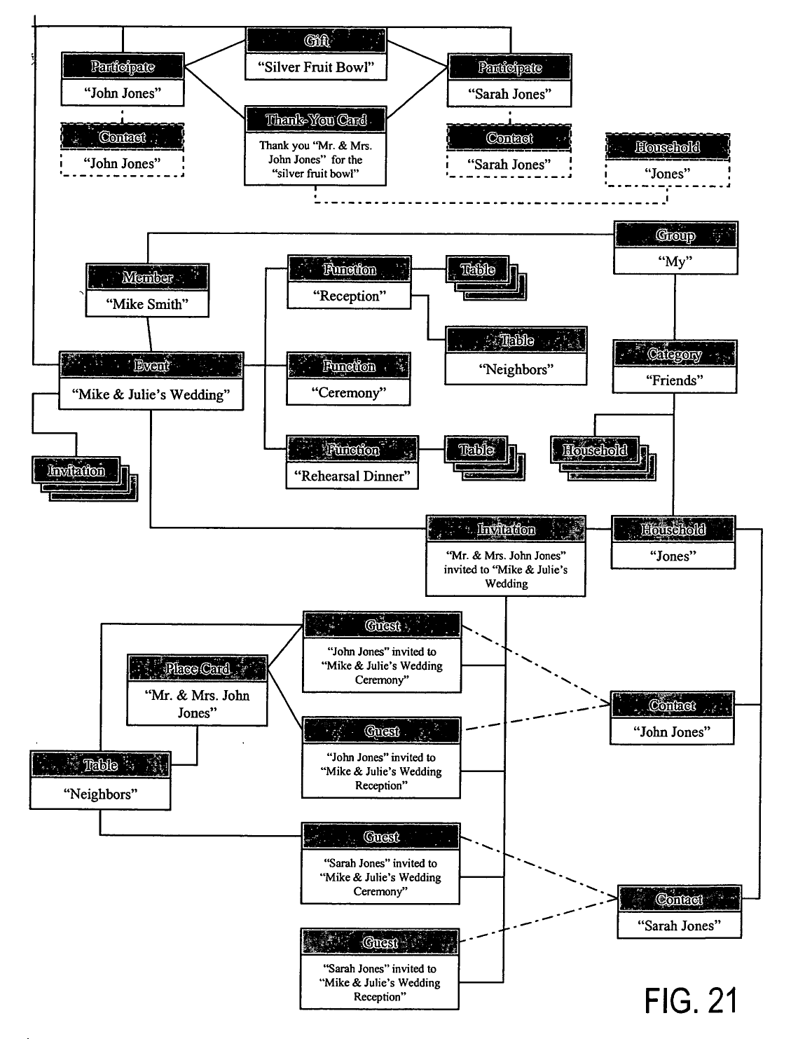

Yet another way that the present invention makes event planning easier, is by allowing attendance and gifts to be entered. Based on the gift entered, thank-you cards can be written and addressed. In FIGS. 20a-20e, Julie Gordon enters in a gift and writes a thank-you card. Julie begins with “Choose Events” screen, in which she chooses her wedding to enter the gifts for. Next, the “Choose Category” screen is displayed. Julie chooses the categories of guests that she wants to enter in gifts for. If Julie knew that she was only going to enter gifts from her side of the family, she would only choose her categories. By choosing fewer categories, fewer guests are displayed which makes choosing the right one easier. In the next screen, “Choose Participating Guests”, all the guests that participated in a gift can be chosen. In the next screen, “Enter Attendance & Gifts”, all the participating guests are marked for attendance and if they participated in the gift. In the lower part of the screen, a number of gifts can be entered. All gifts are entered for the same gift date. Once all the gifts are entered, the user is ready to write the thank-you cards. Because the user already entered in all the pertinent attendance and gift information about each guest, it becomes a simple matter to write out the thank-you cards. Starting in FIG. 20c, Julie starts with the “Choose Event” screen. Attendance will be shown for all selected events. Next, the “Choose Categories” screen is shown. This allows the user to only display guests that fit into a particular category. For example, if a husband and wife agreed that each one would be responsible for their side of the family's thank-you cards, a husband would only select his categories. Next, the “Choose Guests” screen is displayed. Only guests that did not get a thank-you card are listed in this screen. In the next screen, ‘Compose Thank-you card” is where it all comes together. On the top of the screen, the attendance is displayed because it is important to thank people for coming—but only if they come. Also, all gifts that have not been designated as “mentioned in card” are displayed. And finally, the thank-you card itself can be composed on the stop. Similar to the invitation and place card, the etiquette rules can be changed for thank-you cards as well. In the next screen, “Finalize Addressing” the user verifies the addressing and the calligraphy client can hand (or computer) write both the thank-you letter and address the envelope.

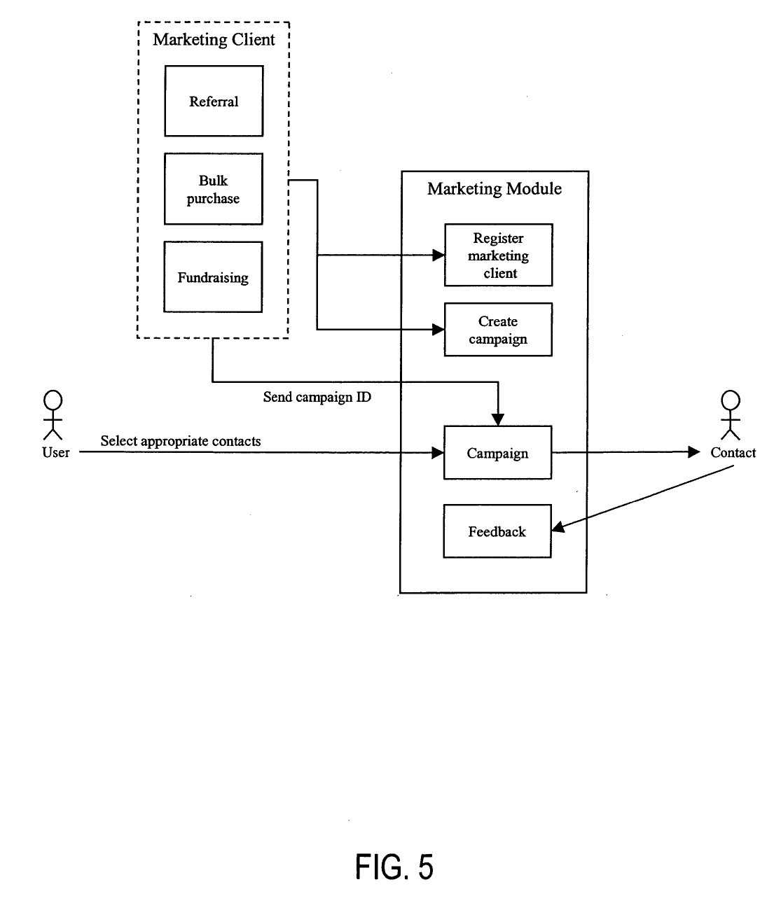

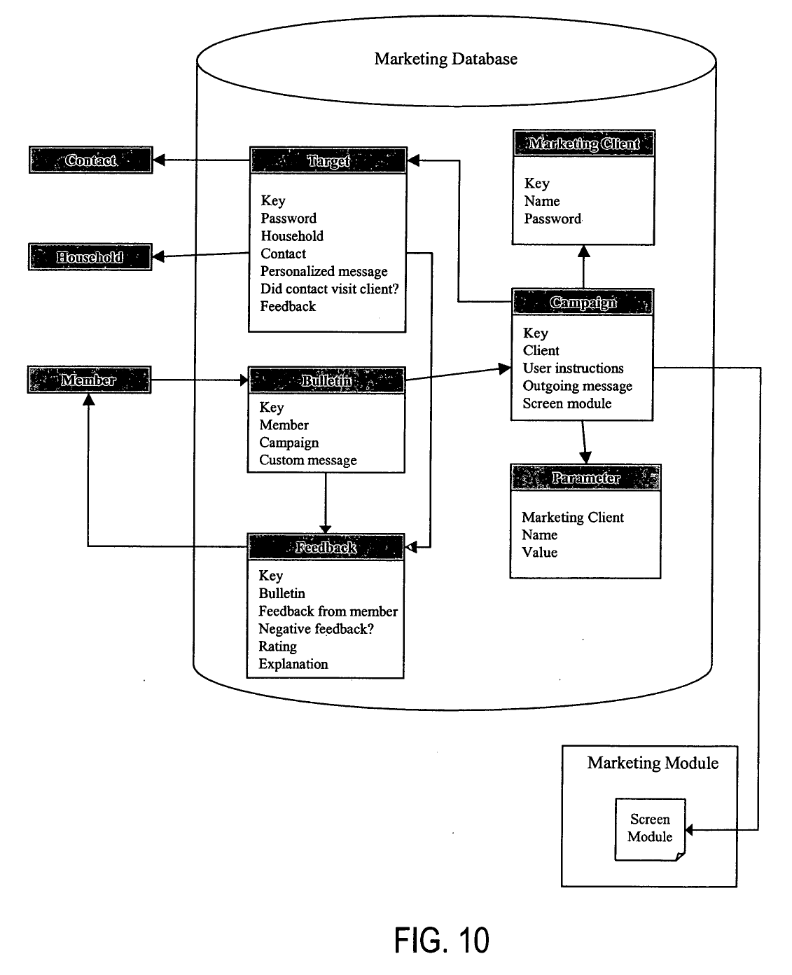

FIG. 5 illustrates the primary functions of the marketing module. FIG. 10 illustrates the database used by the marketing module. For some functions, there may be a sequence of screen that demonstrate the functionality being used.

The goal of the marketing module is to allow companies (“marketing clients”) to utilize a person's contacts for effective marketing. One of the best way to market a product is to have the consumer (“referrer”) who just purchased the product to recommend it to people she knows (“contacts”) who would be the most interested in that product. The reason why this is a better way to market is because
(a) the product is being recommended by the referrer who is an independent source from the company;
(b) the email is coming from the referrer and not a big anonymous company;
(c) the referrer is accessible to the contact to ask questions about the product;
(d) this is one-on-one marketing, which is more personal and targeted then mass marketing;
(e) Because the referrer has many contacts to choose from, the referrer can choose the contacts who the information about her purchase is most applicable to; and
(f) When he a referrer recommends something that she herself believes in enough to buy, it is the best recommendation a product can get. Although the address module could be used by an address client to obtain names, the address module should not be used for marketing purposes. Instead, the marketing module provides a number of functions above the address book module that were designed to regulate marketers so that they do not deluge users' contacts with targeted email, postal mail, and telemarketing campaigns. If that would happen, the value of the marketing module will not only be reduced, but will be considered negative as contacts will not want to purchase products from companies that waste their time. Depending on the nature of the campaign, the following functions may or may not be used:
(a) The user will be limited to how many contacts can be directly targeted. In fact, the more contacts a marketer wishes to the user to choose, the more expensive the campaign will cost the marketing client;
(b) If possible, the referrer will be named as the marketer in the campaign. This means that postal mail will have for the return address, the name and address of the referrer. And email will contain the referrer's email address in the “from” field. This will make the referrer more responsible;
(c) Every direct marketing will contain a short message requesting that the contacts give the referrer feedback. If a contact receives more negative ratings then is acceptable, the user may be restricted from marketing to those contacts;
(d) If multiple users choose the same contact for direct marketing, the separate direct marketing from each user may be bundled together and sent as one direct marketing to the contact from everyone. The benefit of this approach is that the contact should not feel that she's being attacked by everyone with seperate marketing message. This will be accomplished by purposely not sending out the direct marketing right away; and only sending it out after a predetermined waiting period (in days) or after a predetermined number of users target the same contact.
(e) A user may be restricted from choosing the same contacts for direct marketing more then once for a particular campaign.
(f) A user may be restricted from choosing the same contacts for direct marketing more then once in a predetermined amount of time.
(g) The contacts that are not directly targeted will be passively targeted instead. The way that works is that in the same screen that the user chooses the contacts, he will have the option of posting a bulletin about the product in his account. These bulletins will be able to be searched by all users that he's synchronizing his household information with. When users are interested in particular products, they can search through all the bulletins that their family, friends, and colleagues who are linked (synchronized) to them posted. And when they find what they are looking for, they can contact the person who posted it for more information.

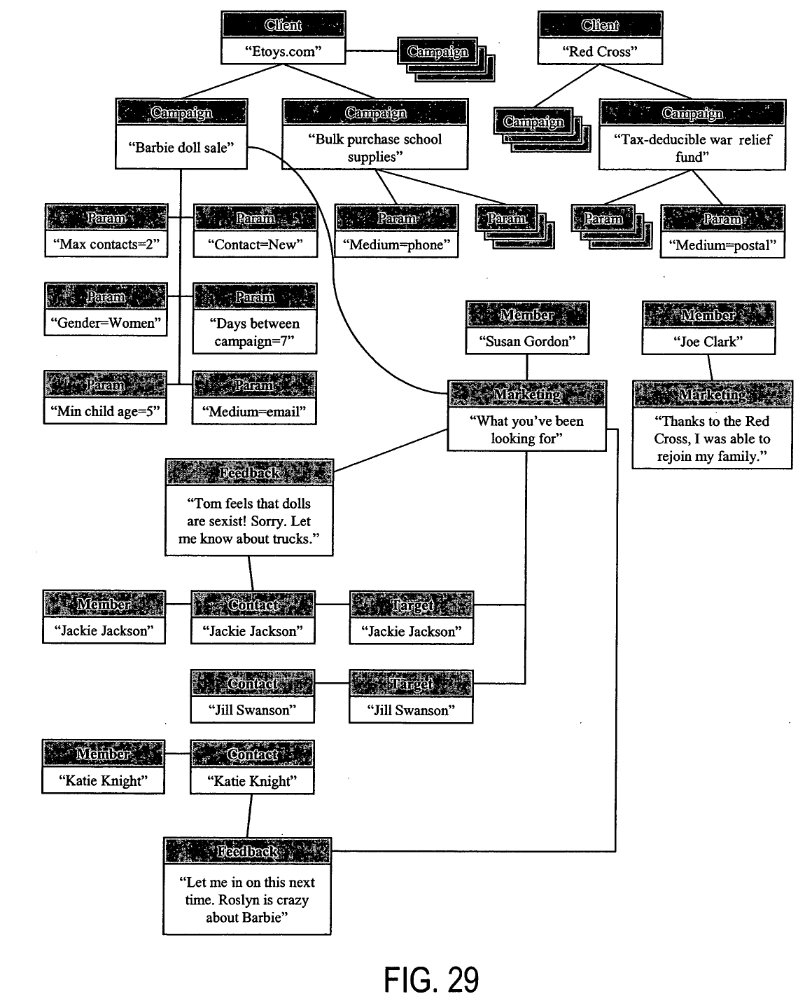

As illustrated in FIG. 10, a Marketing Client has many campaigns. Each campaign is associated with a screen module in the marketing module. This screen module may be a generic screen shared between many clients, or it may be fully customized to suit the needs of a specific client. For more customization, any number of Parameters can be associated with a specific campaign. This gives productHawk.com a mechanism to reuse generic screens for many clients by just adding in customized parameters, and to allow clients to have many similar campaigns running simultaneously, with different parameters for different twists. The benefit of this approach is that it shields the parameters from being changed by the end-user. Only the campaign ID is embedded in the URL link, which, although the end-user can change it, the user will have to guess for the correct campaign ID (and password.) Because the screen can be fully customized, the marketing client can create a specific campaign based on demographics in the address database. By targeting the proper demographics, the campaign can be made more effective. The “Barbie doll sale”, illustrated in FIG. 29 is a campaign that has a very specific target of women with 5-year-old girls. If Mike was the one selecting contacts for this campaign, he would only be allowed to choose women with a 5-year-old girl. Alternatively, for users that have a good track records, the screen may allow them to override the restriction. Or, the initial discount that they receive will be less if they don't choose the proper demographic. And at the same time, they may be promised a higher discount if the contact ends up purchasing the product. There are many different approaches that can be taken, and the custom screen allows every company to make their own marketing decision. The marketing component can be used to market anything which includes but is not limited to websites, information, products, and services. There are many websites that have a “refer to friend” button that allows the user to refer a website to friends. Currently, these websites make the user type in email addresses for each friend, which is very inconvenient. If these websites would link their “refer to friend” button to the marketing component, they would make it much more convenient for their users to choose relevant email addresses. For contacts that are not on the Internet, and do not have an email address, the user can specify that the direct marketing will be sent to them via postal mail, fax, or telephone.

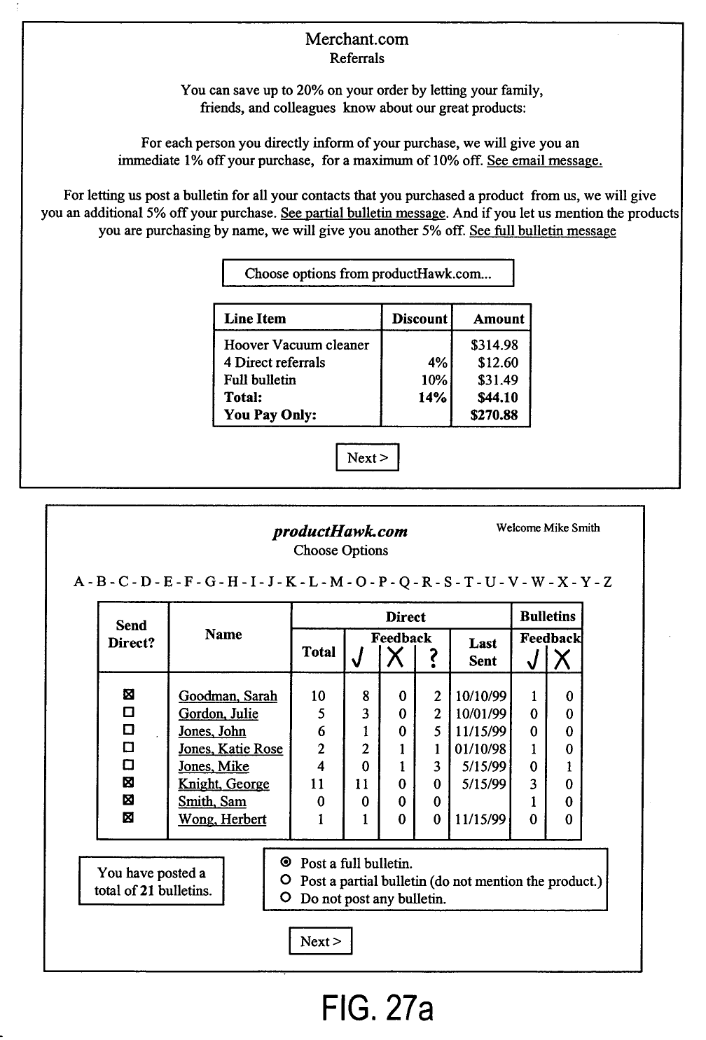

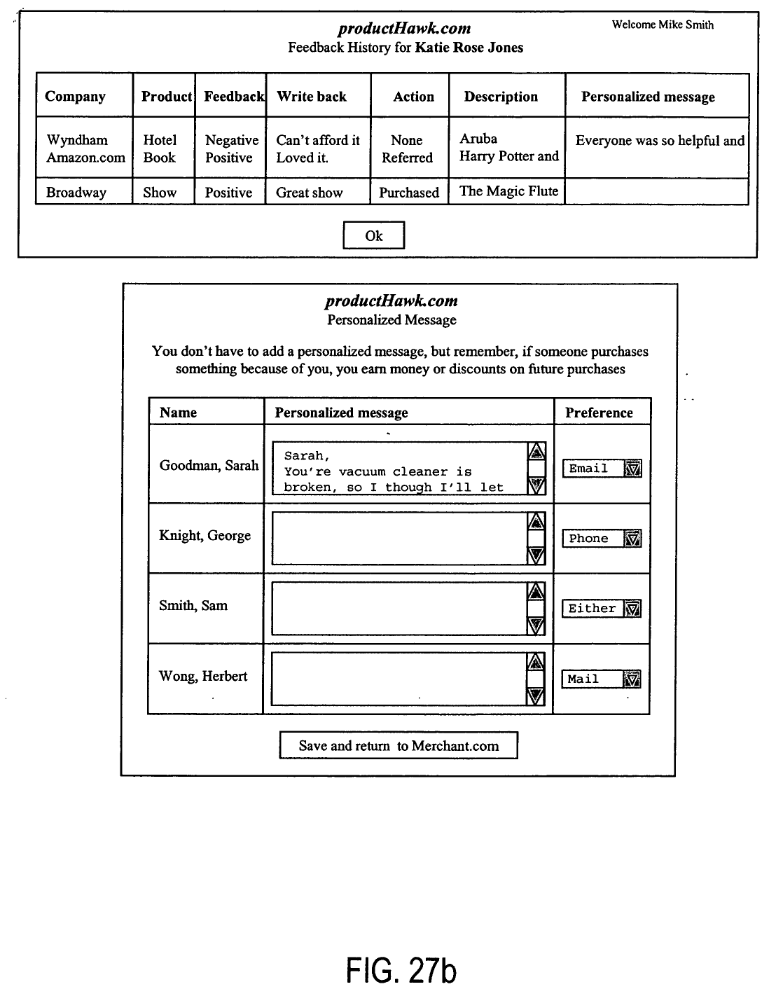

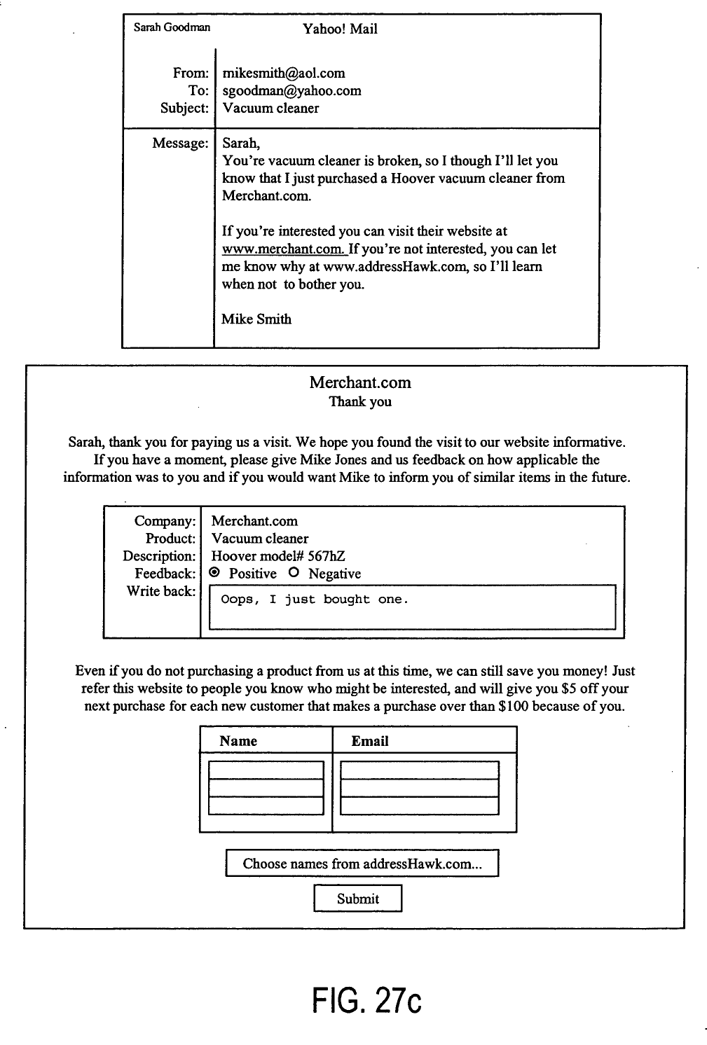

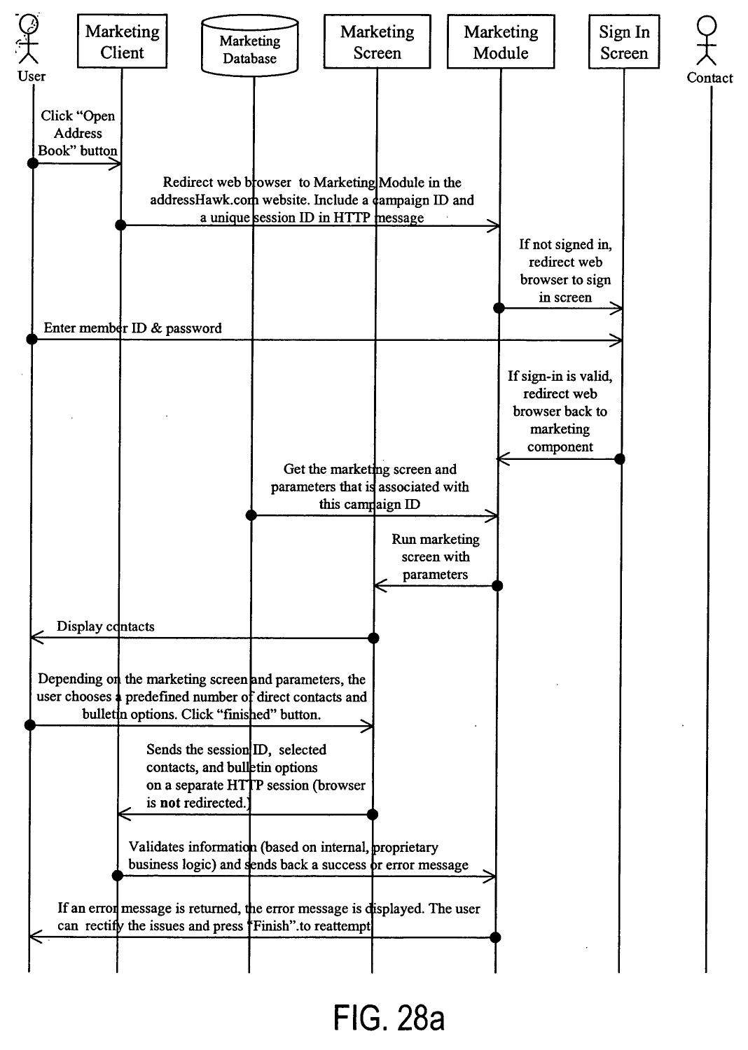

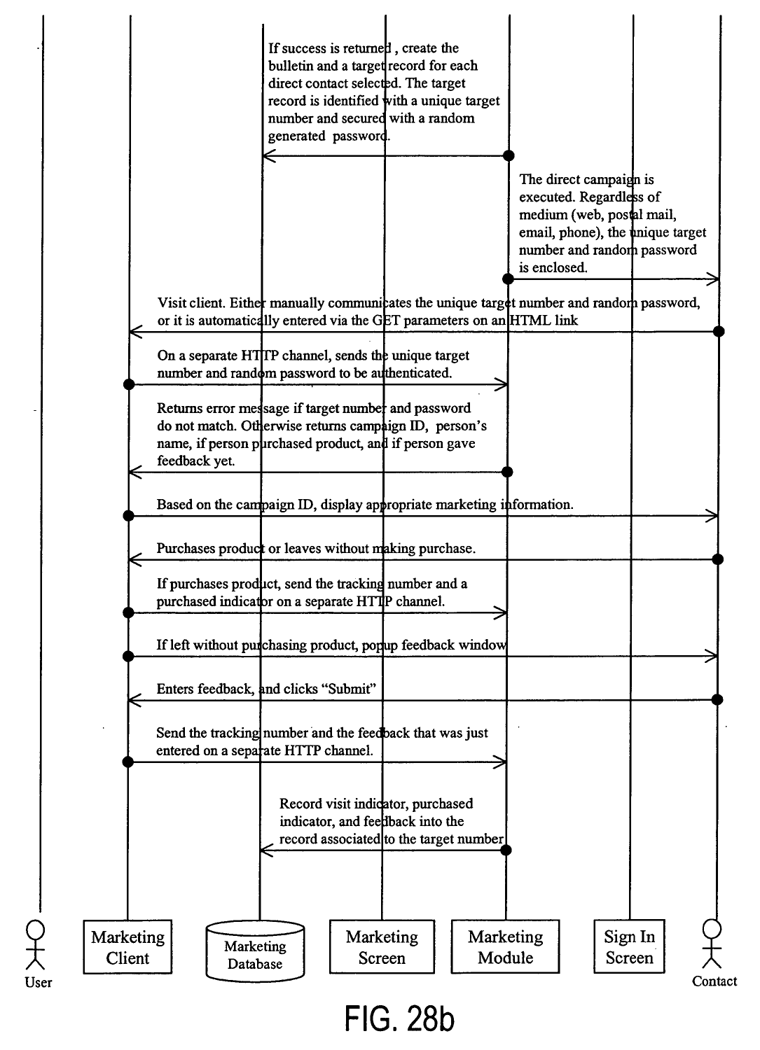

An example of marketing is depicted in FIGS. 27a-27c. In FIG. 27a, Mike Smith is purchasing a Hoover vacuum cleaner. All the numbers in this example are fictional. In some cases, some companies may not even give direct financial incentives, and may give “airline miles” or discount on future purchases, or may require that the targeted contacts actually purchase the product before the referrer receives any compensation. Mike clicks on “choose options from productHawk.com” and is automatically brought into the productHawk.com website. Mike signs in (not shown), and is able to choose multiple contacts to send the purchase information to. Mike also chooses the type of bulletin to post in his account. Although only three bulletin options are shown in this example, the potential bulletin options are unlimited and can be fully customized by a company with specific needs. Notice that Mike has received positive and negative feedback from previous marketing attempts. Also, the date that the last direct marketing was sent out is displayed so that Mike can use his own judgement not to over-do it with one person all the time. (The marketing screen may also be written to restrict Mike from choosing a person that has been chosen to frequently.) The market screen may also be written to restrict the user from choosing a contact who he only has access through sharing. (This can also be an address book privilege.) Feedback is displayed for all bulletins that Mike's contacts found by searching through his account. If Mike's wants to see a particular person's detailed history, he just has to click on the name. In FIG. 27a “Product History”, Mike displayed the product history for Katie Rose Jones. By reviewing the feedback he received from her, he can better decide if he should target her or not. Mike clicks the “Next” button in FIG. 27a screen “Choose Options” and is taken to FIG. 27b screen “Personalize Message”, where Mike can write out a personalized message to each of the contacts. This is not mandatory, and if not written, a generic message is sent instead. In FIG. 27c, Sarah receives the email message and clicks on the Merchant.com link. There is a target number and password embedded in the hyperlink. Merchant.com sends the target number password to producthawk.com to be authenticated. If authenticated, producthawk.com sends back Sarah's identity and the identity of the person that sent her the target email (Mike Smith.) When Sarah leaves the merchant's website, the “Thank-you” screen is displayed in which she is encouraged to give feedback to Mike so that he understands her better in the future. FIGS. 28a-28b describe what is happening behind the screens and is self-explanatory.

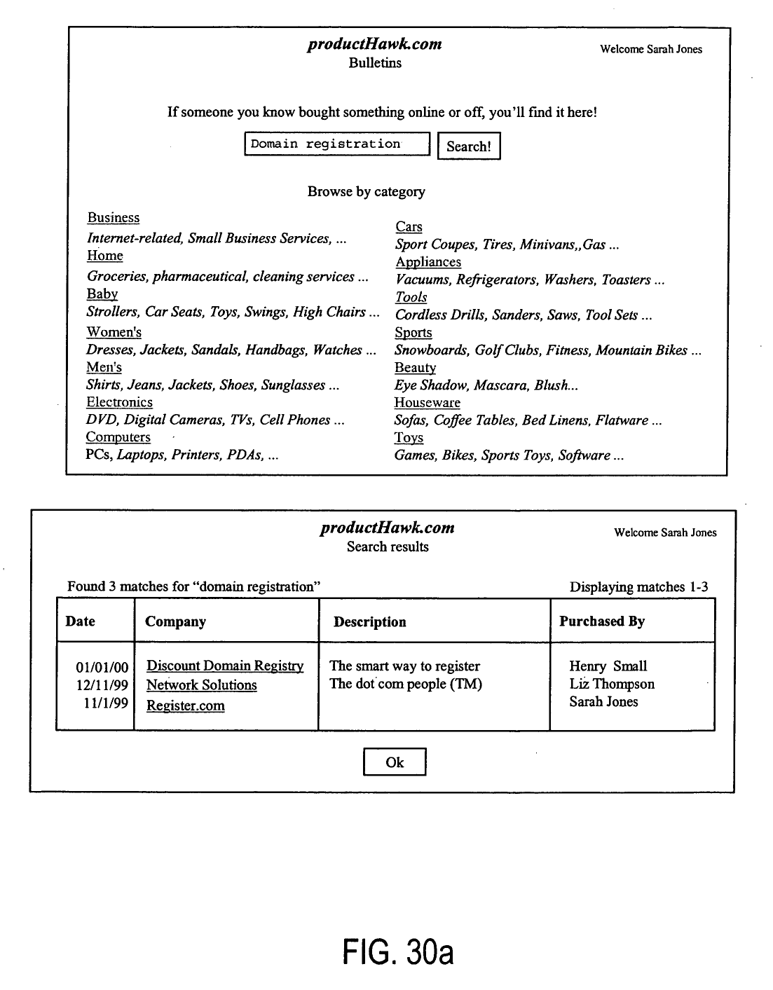

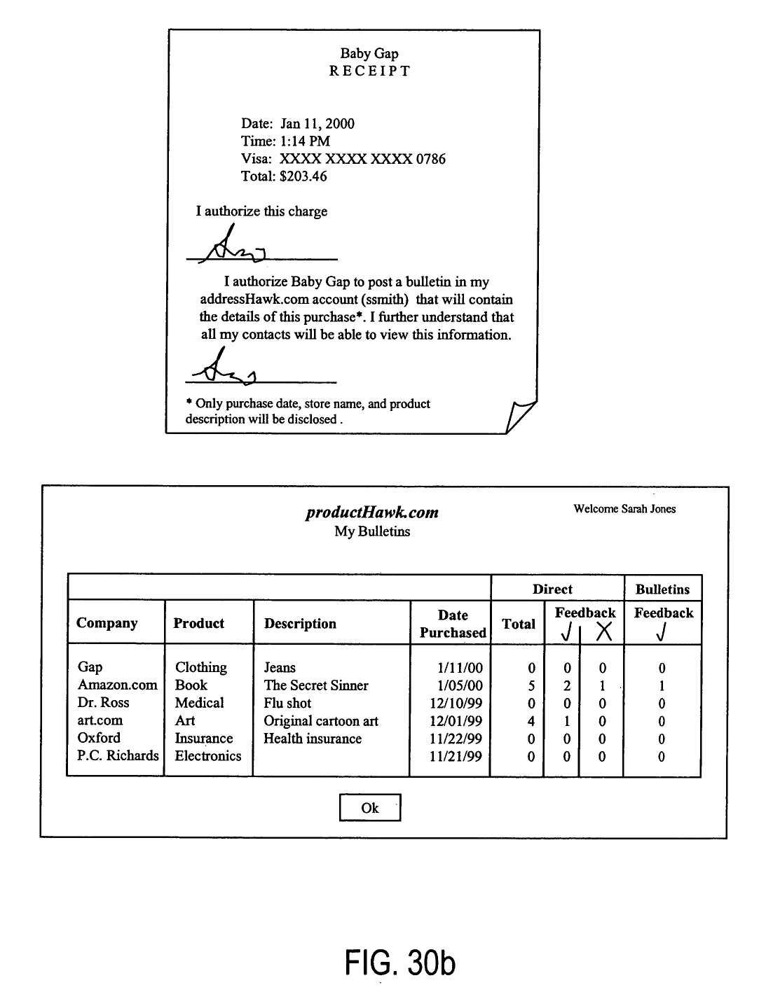

An example of a user searching for product bulletins is depicted in FIG. 30a. In this example, Sarah does a search on domain registering. The search engine tries to match her phrase with every user that she has synchronized her information with who has given her permission to see their bulletins. In the “Set Permission” screen in FIG. 15c, Mike Smith has given Sarah permission to see his bulletins. In fact, the only person who Mike does not let see his bulletins is his father. Also, because Herbert Wong does not let Mike see his household information, he will not be able to see Mike's bulletins either. The search results are displayed in “Search Results” screen. If Sarah clicks on any of the companies, she will be transported to the appropriate website. (Not shown.) The campaign ID and the referral ID will be contained in the hyperlink so that the marketing client knows where the referral came from. At this point Sarah will be able to provide feedback as well. If Sarah purchases something, Mike will get credit and may receive some form of compensation (to be determined and managed by the marketing client).

An example of an offline purchase being posted as a bulletin is depicted in FIG. 30b. The top part shows a receipt with a double signature. What is not shown is that the cashier had asked Sarah permission to post a product bulletin into her account. When she agrees, he asked for her Member ID (account). Sarah is required to sign the receipt in case she later claims that she didn't agree. Not shown on the receipt is the fact that she received some sort of discount in return for her permission. In the next screen “My Bulletins”, the Gap purchase is listed along with all the other bulletins she agreed to post in the past.

1. A method of generating invitations or other documents using an automated computer system comprising the steps of:
providing a user interface whereby a user can enter in specific members of a group and designate such members as being part of a common group;
automatically forming sub-groups within the group, each sub-group to be sent a separate invitation or other documents; and
automatically generating an appropriate salutation for addressing said invitation or other document, said salutation accounting for members of a sub-group being associated with each other.

2. The method of claim 1 wherein the sub-group comprises the most senior members of the household and is generated as a Mr. and Mrs.

3. The method of claim 1 further comprising the steps of:
accepting information indicative of a change in household structure; and
automatically regenerating the groups to associate members of a particular group together when said group changes due to the change in household structure.

4. The method of claim 3 wherein said step of accepting includes accepting information indicative of a marriage, and forming a new group which removes individuals that have been married from their respective former groups, and associates them together into a single new group.

5. The method of claim 1 wherein information of a variety of members is stored in a database accessible over a network, and wherein plural members have a copy of said database, and wherein changes made to said database may be accepted or rejected in copies of said database maintained by other users.

6. Apparatus for maintaining and processing information for generating invitations and other documents, said computer system comprising:
means for generating a user interface, said user interface including a separate entry for each member of a group, each entry including at least a salutation, name, and age; and
means for automatically determining, based upon stored rules of etiquette, which sub-groups of said members should receive a single invitation or other document and which sub-group should receive their own separate invitation or other document.

7. Apparatus of claim 6 wherein a decision regarding which member should receive their own separate invitation or other document accounts for the age of the member.

8. Apparatus of claim 6 wherein a database is maintained and wherein changes to said database result in an immediate and automatic report conveying which particular invitations or other documents need to be reprinted due to such changes.

9. A method of purchasing gifts from a gift registry comprising the steps of:
receiving from a computer names and other information indicative of a plurality of members interested in jointly purchasing a gift;
at a vendor of such item, automatically dividing the cost of said item among said plurality of individuals; and
consummating said order and notifying said individuals of an amount owed by each such individual.

10. The method of claim 9 wherein an agreement to pay his or her share from each individual on said list is obtained prior to shipment of said product.

11. The method of claim 10 wherein said agreement is obtained remotely via e-mail.

12. A network for facilitating the purchase of items jointly by multiple parties, said network comprising:
means for transmitting from a first computer to a vendor computer a list of names in a group of people desiring to purchase a product;
means for automatically dividing the purchase price among said group;
means for notifying each member in the group that he or she has been designated as a participant in a group purchase;
means for accepting and verifying an agreement by each member of said group to pay for his or her share of said purchase; and
means for consummating said purchase upon said agreement from each said member being received.

13. Apparatus of claim 12 wherein a percentage of said purchase price allocated to each group recipient is designated by the individual placing the order, and may be adjusted or desired.

14. A data networking system for facilitating the online purchase of items comprising:
a vendor site for permitting ordering of said items over the Internet;
a hyperlink on said vendor site, said hyperlink providing access to a name and address database;
means for transferring a user to an address database site upon selection of said hyperlink; and
means for permitting a user to select an address from said database site and for, upon said selection, automatically transferring said user back to said vendor site and designating said selected address as an address to which an ordered item from said vendor database will be shipped.

15. Apparatus of claim 14 wherein said means for selecting permits the selection of multiple addresses.

16. A method of ordering a product or service over a data network comprising the steps of:
generating a screen which permits the input of at least a product desired to be ordered;
selecting from a hyperlink on said user interface which transfers the user interface to a name and address database;
choosing at least one name and address from said database; and
upon said step of choosing, returning to said vendor database and permitting said address to be used as a shipping address for said product.

17. The method of claim 16 wherein said step of choosing includes choosing a name other than that of an individual presently ordering said product or service.

18. An information client for interfering with a user over a data network, comprising:
a first user interface having a first hyperlink for transferring said user to a second user interface communicating with a contacts database, said contacts database comprising one or more contacts;
said second user interface having means for selecting contacts and contact information of said selected contacts, and a second hyperlink for automatically transferring said selected contact information to a destination where said contact information is required.

19. The information client of claim 18 wherein said destination is said first user interface.

20. The information client of claim 18 wherein said destination is a third user interface.

21. The information client of claim 18 wherein said destination is a receiving party.

22. The information client of claim 18 is a website.

23. The information client of claim 18 further comprising means for designating a preferred way to contact each of said selected contact.

24. The information client of claim 23 wherein said preferred way is email.

25. The information client of claim 18 wherein said second interface further comprising means for restricting displaying and selecting restricted contacts and contact information according to a predetermined restriction rule, said rule is customized according to purposes of said information client.

26. The information client of claim 25 further comprising means for amending said contacts database from said second interface.

27. The information client of claim 25 further comprising means for restricting said user from selecting contacts that does not have contact information that is required by said information client.

28. The information client of claim 25 wherein said purposes of information client is marketing purposes.

29. The information client of claim 28 wherein said restriction rule prevents said user from selecting contacts when a maximum number of contacts permitted to be selected reaches a predetermined limit.

30. The information client of claim 28 wherein said restriction rule prevents said user from selecting contacts that have been already selected for a same marketing campaign.

31. The information client of claim 28 wherein said restriction rule prevents said user from selecting contacts that have been selected for a predetermined number of campaigns in a predetermined period of time.

32. The information client of claim 28 wherein said restriction rule prevents said user from selecting contacts that do not fit into a particular demographic as defined by said information client.

33. The information client of claim 28 wherein said restriction rule prevents said user from selecting more than a predetermined number of contacts from the same household.

34. The information client of claim 28 wherein said restriction rule prevents said user from selecting contacts that have given more than a predetermined number of negative feedback to said user on previous marketing campaigns.

35. The information client of claim 28 wherein said restriction rule permits said user to select a restricted contact if said user has a good track record based on a number of positive feedback.

36. The information client of claim 28 further comprising means for supplying selected contacts with financial incentives based on number and quality of said contacts defined by said information client.

37. The information client of claim 36 further comprising means for immediately giving said selected contacts with said financial incentives by allowing said selected contacts enjoying an automatic discount on a current purchase.

38. The information client of claim 18 further comprising means for passing a campaign ID on a hyperlink in which said campaign ID is associated to specific rules that customize displaying, filtering and selection restrictions of said contacts database.

39. The information client of claim 18 further comprising means for passing parameters on a hyperlink that customizes displaying, filtering and selection restrictions of said contacts database.

40. The information client of claim 28 further comprising means for said selected contacts to give said user positive or negative feedback that will assist said user in making marketing decisions in the future.

41. The information client of claim 28 further comprising means for bundling together marketing information from a plurality of said users targeting a same contact and for sending said marketing information as a single marketing message to said contact.

42. The information client of claim 18 wherein said contact information is to be used for purpose of delivering an item to another person.

43. The information client of claim 42 wherein said contact information is to be used for purpose of coordinating a purchase among multiple contacts.

44. The information client of claim 18 wherein said contact information is to be used to effectuate a purchase of an item for another person.

45. The information client of claim 44 wherein said item is deliverable by email.
